(19) United States
(12) Patent Application Publication
(10) Pub. No.: US 2025/0002689 A1
(43) Pub. Date: Jan. 2, 2025

(54) PRESSURE SENSITIVE ADHESIVE TAPE, ARTICLE, AND METHOD OF DISMANTLING ARTICLE

(71) Applicant: DIC Corporation, Tokyo (JP)

(72) Inventors: Junko Kanda, Saitama (JP); Hiromasa Kikuchi, Chiba (JP); Yusuke Takahashi, Saitama (JP); Takahiro Obi, Saitama (JP)

(73) Assignee: DIC Corporation, Tokyo (JP)

(21) Appl. No.: 18/758,227

(22) Filed: Jun. 28, 2024

(30) Foreign Application Priority Data
Jun. 30, 2023 (JP) 2023-107714

(51) Int. Cl. C08K 7/28; B32B 7/12; B32B 17/10; B32B 27/20; B32B 27/30; B32B 43/00; C09J 5/00; C09J 7/38; C09J 11/04

(52) U.S. Cl. CPC C08K 7/28; B32B 7/12; B32B 17/10; B32B 27/20; B32B 27/302; B32B 43/006; C09J 5/00; C09J 7/385; C09J 7/387; C09J 11/04; B32B 2307/302; B32B 2325/00; C08K 2201/003; C09J 2301/302; C09J 2301/502

(57) ABSTRACT

A pressure sensitive adhesive tape including at least a pressure sensitive adhesive layer, a heat-generating element, and a melt-softening layer adjacent to the heat-generating element in this order is provided. The melt-softening layer contains a thermoplastic resin and an inorganic hollow filler.

### TECHNICAL FIELD

The present invention relates to a pressure sensitive adhesive tape, an article, and a method of dismantling the article. Specifically, the present invention relates to a pressure sensitive adhesive tape that can be applied to various fields such as production of electronic devices, an article configured to be bonded by the pressure sensitive adhesive tape, and a method of dismantling the article.

### BACKGROUND

A pressure sensitive adhesive tape has been used, as bonding means with excellent workability and high adhesion reliability, in various industrial fields such as office automation equipment, IT products, household electric appliances, and automobiles for fixing components, temporarily fixing components, and labeling to display product information. In recent years, from the viewpoint of protecting the global environment, there has been an increasing demand for recycling and reusing used products in various industrial fields such as household electric appliances and automobiles. In a case of recycling and reusing various products, an operation of peeling off the pressure sensitive adhesive tape used to fix components or used for labels is required to perform, but the pressure sensitive adhesive tape is provided in various places of a product, and therefore, there is a demand for reducing the operational cost by performing a simple removal process.

In order to separate adherends from each other, for example, a hot melt adhesive composition that is dissolved in a short time at a high speed by electromagnetic induction heating has been suggested (for example, see Japanese Unexamined Patent Application Publication No. 2002-188068). As a method of separating adherends from each other, a method of dismantling a building by heating a metal base material using an electromagnetic induction heating device so that an adhesive between the base material and an interior material is heated, foamed, and peeled off, and peeling off the interior material from the metal base material (for example, see Japanese Unexamined Patent Application Publication No. 2006-200279).

Further, double-sided adhesive tape including a thermally conductive layer that can easily dismantle an article by being brought into contact with a heat-generating source so that the thermally conductive layer is directly heated has been suggested (for example, see Japanese Unexamined Patent Application Publication No. 2016-108394). However, since heat is applied from the outside in a method of peeling and dismantling by heating in the related art, in a case where the amount of heat required to peel off a pressure sensitive adhesive tape is intended to be generated from a heat-generating element, the generated heat may cause thermal degradation or thermal damage to an adherend in some cases. Meanwhile, when the thermal degradation or thermal damage to the adherend is intended to be suppressed, the pressure sensitive adhesive tape is not sufficiently heated due to a decrease in amount of heat generated and thus is unlikely to be peeled off in some cases. Therefore, there is a demand for a pressure sensitive adhesive tape having a function of dismantling a component which is an adherend so that the component can be reused in the pressure sensitive adhesive tape that fixes adherends such as rigid objects, and particularly a pressure sensitive adhesive tape having a function of easily dismantling an article and being easily peeled off when heated has been required.

### SUMMARY

An object of the present invention is to provide a pressure sensitive adhesive tape that can be easily heated and peeled off in a short time, can prevent thermal damage to an adherend, and enables a heating and peeling operation to be easily performed, an article configured to be bonded by the pressure sensitive adhesive tape, and a method of dismantling the article.

The present invention relates to the following (1) to (18).

(1) A pressure sensitive adhesive tape including at least in the following order: a pressure sensitive adhesive layer; a heat-generating element; and a melt-softening layer adjacent to the heat-generating element, in which the melt-softening layer contains a thermoplastic resin and an inorganic hollow filler.

(2) The pressure sensitive adhesive tape according to (1), in which the thermoplastic resin constituting the melt-softening layer contains a block copolymer consisting of a polymer block having a structural unit derived from an aromatic vinyl compound and a polymer block having a structural unit derived from a conjugated diene compound, or a hydrogenated product thereof.

(3) The pressure sensitive adhesive tape according to (1) or (2), in which an amount of the inorganic hollow filler to be blended into the melt-softening layer is in a range of 5% to 80% by volume.

(4) The pressure sensitive adhesive tape according to any one of (1) to (3), in which the inorganic hollow filler has an average particle diameter of 1 to 200 μm.

(5) The pressure sensitive adhesive tape according to any one of (1) to (4), in which the inorganic hollow filler is at least one or more selected from the group consisting of a glass hollow filler and a silica hollow filler.

(6) The pressure sensitive adhesive tape according to any one of (1) to (5), in which the melt-softening layer has a thickness of 10 to 200 μm.

(7) The pressure sensitive adhesive tape according to any one of (1) to (6), in which the melt-softening layer has a thermal conductivity of 0.03 to 0.20 W/m·K.

(8) The pressure sensitive adhesive tape according to any one of (1) to (7), in which a temperature at which a loss tangent (tan δ) of a component containing the thermoplastic resin, other than the inorganic hollow filler, constituting the melt-softening layer is 0.8 or greater is 80° C. or higher.

(9) The pressure sensitive adhesive tape according to any one of (1) to (8), in which a temperature at which a loss tangent (tan δ) of the pressure sensitive adhesive layer is 0.8 or greater is higher than a temperature at which a loss tangent (tan δ) of a component containing the thermoplastic resin, other than the inorganic hollow filler, constituting the melt-softening layer is 0.8 or greater.

(10) The pressure sensitive adhesive tape according to any one of (1) to (9), in which a volume resistivity of the heat-generating element at 20° C. is 30 μΩ·cm or greater.

(11) The pressure sensitive adhesive tape according to any one of (1) to (10), in which the heat-generating element has a pair of extending portions extending from outer peripheries of the pressure sensitive adhesive layer and the melt-softening layer in plan view.

(12) The pressure sensitive adhesive tape according to any one of (1) to (11), further including: a pressure sensitive adhesive layer on a surface side of the melt-softening layer opposite to a surface adjacent to the heat-generating element.

(13) The pressure sensitive adhesive tape according to any one of (1) to (12), in which the melt-softening layer is peelable when heated.

(14) The pressure sensitive adhesive tape according to any one of (1) to (13), in which the heat-generating element is an electrically conducting element that generates heat through electrical conduction and is peeled off when the conducting element generates heat.

(15) An article including: at least two adherends; and the pressure sensitive adhesive tape according to any one of (1) to (14) between the two adherends, in which the two adherends are bonded to each other through the pressure sensitive adhesive tape.

(16) The article according to (15), in which the heat-generating element constituting the pressure sensitive adhesive tape has a pair of extending portions extending from outer peripheries of the adherends in plan view.

(17) A method of dismantling the article according to (15) or (16), including: separating the two adherends from each other by heating the heat-generating element to melt and/or soften the melt-softening layer.

(18) The method of dismantling an article according to (17), in which the heating of the heat-generating element is resistance heating, the heat-generating element and a power source are electrically connected to each other, the heat-generating element is electrically conducted from the power source, and the melt-softening layer is melted and/or softened by the resistance heating to separate the two adherends from each other.

According to the present invention, it is possible to provide a pressure sensitive adhesive tape that can be easily heated and peeled off in a short time, can prevent thermal damage to an adherend, and enables a heating and peeling operation to be easily performed.

Further, according to the present invention, it is possible to further provide an article configured such that at least two adherends are bonded to each other through the pressure sensitive adhesive tape and a method of dismantling the article, thermal degradation of the adherends such as electronic components is suppressed so that the article can be reused, and the dismantling operation is easily performed.

### BRIEF DESCRIPTION OF THE DRAWINGS

FIG. 1 is a schematic cross-sectional view showing an example of a pressure sensitive adhesive tape of the present invention.

FIG. 2 is a schematic cross-sectional view showing another example of the pressure sensitive adhesive tape according to the present invention.

FIG. 3 is a schematic cross-sectional view showing still another example of the pressure sensitive adhesive tape according to the present invention.

FIGS. 4-1 to 4-9 are schematic plan views showing an example of a pattern of a heat-generating element in the pressure sensitive adhesive tape according to the present invention.

FIG. 5 is a schematic cross-sectional view showing still another example of the pressure sensitive adhesive tape according to the present invention.

FIG. 6 is a schematic plan view showing an example of an article according to the present invention.

FIG. 7 is a schematic cross-sectional view showing an example of the article according to the present invention.

FIG. 8 is a view schematically showing a method of dismantling the article according to the present invention.

FIG. 9 is a schematic plan view showing a pressure sensitive adhesive tape of Example 1.

FIG. 10 is a schematic cross-sectional view showing the pressure sensitive adhesive tape of Example 1.

FIG. 11 is a schematic plan view showing an article of an example and a method of evaluating the article.

FIG. 12 is a schematic front view showing an article of an example and a method of evaluating the article.

FIG. 13 is a schematic side view showing an article of an example and a method of evaluating the article.

### DETAILED DESCRIPTION

Hereinafter, embodiments of the present invention will be described in detail. Further, in the present specification, a numerical range shown using “to” denotes a range including the numerical values described before and after “to” as the minimum value and the maximum value.

### 1. Pressure Sensitive Adhesive Tape

The present invention relates to a pressure sensitive adhesive tape including at least a pressure sensitive adhesive layer, a heat-generating element, and a melt-softening layer adjacent to the heat-generating element in this order, and the melt-softening layer contains a thermoplastic resin and an inorganic hollow filler.

The pressure sensitive adhesive tape of the present invention has a melt-softening layer which can be peeled off when heated, and can be used as an easily dismantling pressure sensitive adhesive tape that can easily separate or dismantle fixed adherends from each other after a certain period of time from the attachment to the adherends and the fixation of the adherends to each other. Since the pressure sensitive adhesive tape of the present invention has the above-described configuration, the pressure sensitive adhesive tape maintains high adhesive strength during fixation of adherends to each other regardless of the materials of the adherends and easily separates or dismantles the adherends when heated in a case of separating or dismantling the adherends. Hereinafter, “separate or dismantle” will also be simply referred to as “dismantle”.

The pressure sensitive adhesive tape of the present invention includes a heat-generating element. Such a heat-generating element is directly electrically conducted or generates heat by heating means such as induction heating or irradiation with external energy such as infrared rays or microwaves so that the melt-softening layer adjacent to the heat-generating element is melted or softened. In the present invention, since deterioration of the adherends due to irradiation with external energy can be suppressed and the article can be dismantled in a state where the pressure sensitive adhesive tape is embedded in the article, it is preferable that the heat-generating element is an electrically conducting element that generates heat through electrical conduction, and an aspect in which the pressure sensitive adhesive tape of the present invention is peeled off when the electrically conducting element generates heat is preferable.

Here, since the melt-softening layer of the pressure sensitive adhesive tape according to the present invention contains an inorganic hollow filler, the pressure sensitive adhesive tape exhibits a heat insulation effect of suppressing conduction of heat generated from the heat-generating element to the adherends and an effect of storing heat in the melt-softening layer. Due to such effects, the thermoplastic resin constituting the melt-softening layer can be effectively melted or softened.

Therefore, in the pressure sensitive adhesive tape of the present invention, the adhesive strength decreases as the heat-generating element generates heat due to the heat storage effect of the melt-softening layer, the residual adhesive strength after electrical conduction is less than the initial adhesive strength, and a rate of decrease in adhesive strength due to electrical conduction increases. Accordingly, the article prepared by using the pressure sensitive adhesive tape of the present invention has excellent dismantling properties.

In other words, the pressure sensitive adhesive tape of the present invention generates heat inside the tape, and thus in a case of dismantling an article formed such that at least two adherends are bonded through the pressure sensitive adhesive tape of the present invention, the article can be easily dismantled while the thermal damage to the adherends is reduced.

Further, even in an article obtained by bonding electronic components in which the pressure sensitive adhesive tape is embedded in the equipment so that the pressure sensitive adhesive tape cannot be accessed and completely shielded from the outside without, the electronic components can be easily dismantled without preparing a large-scale device. Particularly in a case of thermally dismantling the pressure sensitive adhesive tape using a driving current inside electronic components in a state where the pressure sensitive adhesive tape is embedded in an electronic device, thermal degradation and the like of circuits inside the electronic components can be prevented and the pressure sensitive adhesive tape can be heated and peeled off without preparing an external device and the like, and thus the dismantling operation can be easily performed.

The aspect in which the pressure sensitive adhesive tape of the present invention “can be peeled off when heated” may be an aspect in which inside the pressure sensitive adhesive tape, particularly the melt-softening layer itself is melted or softened when heated so that cohesive failure is caused in the inside of the melt-softened layer, and thus a part or the entirety of the pressure sensitive adhesive tape is peeled off from the adherend or an aspect in which inside the pressure sensitive adhesive tape, particularly the melt-softening layer itself is melted or softened when heated so that the adhesive strength thereof is decreased, the melt-softening layer and a layer adjacent to the melt-softening layer or the melt-softening layer and an adherend are peeled off from each other (interfacial failure), and thus a part or the entirety of the pressure sensitive adhesive tape can be peeled off from the adherend. Further, when the pressure sensitive adhesive tape is peeled off when heated, the melt-softening layer may be peeled off from the adherend integrally with the pressure sensitive adhesive tape or a part of the melt-softening layer may be peeled off from the adherend.

Further, the pressure sensitive adhesive layer constituting the pressure sensitive adhesive tape of the present invention is formed of components that are difficult to melt or soften when heated as compared with the components constituting the melt-softening layer as described below. Further, since the melt-softening layer contains an inorganic hollow filler, the melt-softening layer stores heat received from the heat-generating element and thus can retain heat. Therefore, the pressure sensitive adhesive tape of the present invention causes the heat-generating element to generate heat so that the melt-softening layer is heated and selectively melted or softened, and thus the pressure sensitive adhesive tape can be peeled off from the adherend.

Hereinafter, the configuration of the pressure sensitive adhesive tape of the present invention will be described.

### [Heat-Generating Element]

A known heat-generating element can be appropriately selected as the heat-generating element depending on the heating means to be used. Examples of the heating and the heating means include resistance heating and electromagnetic induction heating, infrared heating, microwave heating, and thermal conduction. Among these, from the viewpoint that the melt-softening layer can be sufficiently softened or melted even with a small amount of energy and, for example, the pressure sensitive adhesive tape can be thermally dismantled using the driving current inside electronic components in a state where the pressure sensitive adhesive tape is embedded in electronic equipment and from the viewpoint that the heat-generating element does not need to be heated by using an external heat source through an adherend and thus excessive heating of the adherend can be prevented, resistance heating is preferable.

Here, “resistance heating” is a type of electrical heating method in which a current is allowed to flow in an electrically conducting element (heat-generating element) having resistance so that the electrically conducting element is heated by the Joule's heat. When a steady current is allowed to flow in the electrically conducting element, the amount of Joule's heat generated within a certain time is proportional to the square to the magnitude of the current and the resistance of the conducting wire (Joule's law). The electrically conducting element has a resistance value specific to the substance thereof (volume resistivity or the like).

Further, “electromagnetic induction heating” is a non-contact heating method as a type of electrical heating method, and is also referred to as high-frequency induction heating. When an electrically conducting element (heat-generating element) having resistance is placed in a magnetic field generated by allowing a high-frequency current (alternating current) to flow in a coiled conducting wire, a current flows in the electrically conducting element based on the principle of electromagnetic induction, and thus the electrically conducting element is heated by the Joule's heat.

“Infrared heating” and “microwave heating” are non-contact heating methods using thermal energy generated by radiation and using electromagnetic waves having a specific wavelength range, such as infrared rays or microwaves. The atomic bonds and molecules constituting a substance undergo thermal vibration (molecular motion and crystal lattice vibration) according to the temperature of the substance itself, and the molecular vibration is intense and heat is generated when the electromagnetic waves having a wavelength corresponding to the vibration frequency are absorbed.

“Thermal conduction” is a heating method using a heat transfer phenomenon in which heat is transferred from a high-temperature side to a low-temperature side inside a solid, and heat is transferred by bringing a heat-generating source into direct contact with a substance with excellent thermal conductivity.

In a case where the heating means is resistance heating, it is preferable that the heat-generating element be an electrically conducting element having resistance, and examples thereof include metals, non-metals, and organic/inorganic composite materials.

Examples of the metals include nichrome (108 μΩ·cm); stainless steel such as SUS410 (62.2 μΩ·cm), SUS304 (72.0 μΩ·cm), or SUS430 (60.0 μΩ·cm); titanium (55.0 μΩ·cm); nickel silver (for example, “Nickel Silver C7701”, manufactured by TAKEUCHI METAL FOIL & POWDER CO., LTD., 34.0 μΩ·cm), and metal fiber sheets (for example, “Stainless Fiber Sheet”, manufactured by TOMOEGAWA CORPORATION). Further, the numerical values in the parentheses denote approximate volume resistivities of the respective substances at 20° C.

Among these, nichrome and stainless steel are preferable from the viewpoint that these are difficult to tear when formed into a foil and easily handled as tape, and the adhesive strength can be greatly reduced by melting the melt-softening layer in a short time.

Examples of the non-metals include carbons (3, 352 μΩ·cm as an example) such as carbon nanomaterials, for example, graphite, graphene, graphene oxide, carbon nanotubes, graphene platelets, and carbon nanofibers. Among these, carbon nanomaterials such as carbon nanotubes are preferable from the viewpoints of being easily processed to a film, being difficult to impair the physical properties such as followability required for a tape, easily exhibiting the electric conductivity even with a small amount of the material, and being capable of melting the melt-softening layer by resistance heating in a short time.

Examples of the organic/inorganic composite material include a metal-deposited film in which a metal such as aluminum or chromium is deposited on a polyester film, a conductively plated woven or non-woven fabric, and a conductively coated film.

In a case where the heating means is resistance heating, the volume resistivity of the heat-generating element at 20° C. is preferably 30 μΩ·cm or greater, more preferably 50 μΩ·cm or greater, still more preferably 70 μΩ·cm or greater, and particularly preferably 100 μΩ·cm or greater. From the viewpoint that the voltage required to electrically conduct the heat-generating element is adjusted not to be extremely high, the volume resistivity of the heat-generating element at 20° C. is preferably 100,000 μΩ·cm or less, more preferably 20,000 μΩ·cm or less, still more preferably 10,000 μΩ·cm or less, and particularly preferably 5,000 μΩ·cm or less. Specifically, the volume resistivity of the heat-generating element can be adjusted to be in a range of 30 to 100,000 μΩ·cm, a range of 50 to 20,000 μΩ·cm, a range of 70 to 10,000 μΩ·cm, or a range of 100 to 5,000 μΩ·cm.

When the volume resistivity of the heat-generating element is 30 μΩ·cm or greater, only the pressure sensitive adhesive tape can be heated in a case where the heat-generating element is connected to a wire circuit inside electronic equipment during dismantling of an article so that the heat-generating element is electrically conducted with the driving current of the electronic equipment, and thus high-temperature degradation of the wiring circuit can be prevented. Further, a heat-generating element in which the volume resistivity is in the above-described range is used, the melt-softening layer can be melted or softened in a short time, and therefore, the dismantling time can be shortened.

Further, in a case where the driving current inside the electronic component is used, overheating of the electronic circuit and the connected portion due to electrical conduction to the heat-generating element can be prevented, and as a result, thermal degradation of the electronic component can be prevented.

The volume resistivity of the heat-generating element can be measured at 20° C. in conformity with JIS K 7194 using a low resistivity meter (trade name “Loresta-AX MCT-T370”, manufactured by Nittoseiko Analytech Co., Ltd.) and a four-point probe (trade name “ASP Probe MCP-TP03P”, manufactured by Nittoseiko Analytech Co., Ltd.). The number of measuring points is set to one point, and 4.532 is used as the correction coefficient of the resistivity.

In a case where the heating means is electromagnetic induction heating, it is preferable that the heat-generating element be an electrically conducting element having resistance, and examples thereof include metals such as iron, aluminum, nickel, stainless steel, zinc, lead, and magnesium, and oxides and alloys of these metals. Among these, aluminum or iron is preferable.

In a case where heating means is infrared heating or microwave heating, it is preferable that the heat-generating element be a substance having a property of absorbing a specific wavelength of the infrared heating or the microwave heating and thermally vibrating (generating heat), and examples thereof include an organic substance and an inorganic substance.

Examples of the organic substance include a resin, rubber, fibers, an organic coloring material, an organic dye, and an organic pigment. Examples of the inorganic substance include a metal-based inorganic substance, a non-metal-based inorganic substance, an inorganic coloring material, an inorganic dye, and an inorganic pigment. Examples of the metal-based inorganic substance include non-ferrous metals such as aluminum, titanium, chromium, manganese, cobalt, nickel, magnesium, zinc, and copper, iron, and oxides of the non-ferrous metal and iron. Examples of the non-metal-based inorganic substances include silicon, carbon, and a silicon oxide (for example, SiO2).

In a case where the heating means is thermal conduction, it is preferable that the heat-generating element be a substance with excellent thermal conductivity, and examples thereof include metals and non-metals. Examples of the metals include aluminum, iron, copper, and oxides of these metals. Examples of the non-metals include ceramics such as silicon carbide, and graphite.

In a case where the heating means is resistance heating, the shape of the heat-generating element can be appropriately selected depending on the purpose thereof without particular limitation as long as heat-generating elements have a shape of being in electrical contact with each other so that resistance heating can be caused, and examples thereof include a planar shape, a mesh shape, a particle shape, and a fibrous shape. Among these, from the viewpoint that the heat-generating element can be sufficiently bonded to the melt-softening layer that is in contact with the heat-generating element before electrical conduction, and the heat-generating element generates heat from the surface thereof during electrical conduction so that the heat-generating element is unlikely to be destroyed or broken during electrical conduction and dismantling, the planar shape is preferable.

Examples of the planar heat-generating element include metal foils formed of the above-described metals; sheets of the above-described non-metals; resin films or sheets in which particles or fibers formed of the above-described metals or the above-described non-metals are highly densely dispersed, such as metal-deposited films, conductively plated woven or non-woven fabrics, or conductively coated films; coating films formed of the metals or non-metals; sheets in which non-woven fabrics are impregnated with the metals or non-metals; and non-woven fabrics of the metals or non-metals such as metal fiber sheets.

Among these, from the viewpoint that the entire surface can be heated and disconnection is unlikely to occur, metal foils, sheets of non-metals, coating films of metals or non-metals, and non-woven fabrics of metals or non-metals are preferable, and metal foils are more preferable.

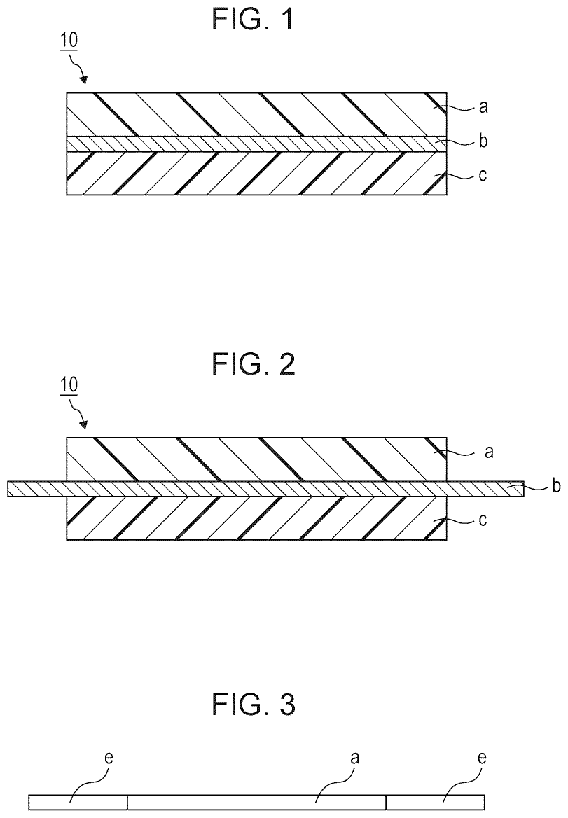

The planar heat-generating element may be molded in the form of a pattern, or may be band-like or linear (see FIGS. 4-1 to 4-9 shown below). It is advantageous that the heat-generating element is band-like or linear in terms that the heat generation efficiency is high and the heat-generating element is easily peeled off due to a small contact area with the adherend. In this case, the length (the band width or the line width) of the heat-generating element in a minor axis direction is preferably in a range of 0.5 to 20 mm, more preferably in a range of 1 to 10 mm, and still more preferably in a range of 2 to 5 mm.

When the planar heat-generating element is pattern-like (having a pattern shape), the distance between terminals (terminals for connecting the heat-generating element to the power source) of the heat-generating element can be increased, and the resistance can be increased. Therefore, the heat generation efficiency of the planar heat-generating element is enhanced, and thus the pressure sensitive adhesive tape of the present invention can be peeled off in a short time. The pattern width in a case where the planar heat-generating element is pattern-like is not particularly limited, and the preferable aspects thereof can be set to be the same as the preferable aspects of the band width.

The planar heat-generating element may be disposed on one or both surfaces of a base material. In this case, the heat-generating element may be disposed to be in direct contact with one or both surfaces of the base material. Further, the heat-generating element may be disposed to cover the entire area of one or both surfaces of the base material or may be disposed in the form of a line, a band, or a pattern. The base material is not particularly limited as long as the base material can support the heat-generating element, and a film formed of a resin such as polyester such as polyethylene terephthalate or polyethylene naphthalate, polyolefin such as polypropylene, or polyimide is preferable from the viewpoints of the followability, reduction of the film thickness, and the heat resistance of the pressure sensitive adhesive tape.

Examples of the mesh-like heat-generating element include a planar heat-generating element having a plurality of through-holes and a mesh-like or lattice-like heat-generating element. These heat-generating elements may be heat-generating elements that are integrally molded.

Further, as the shape of the heat-generating elements, the heat-generating elements may not be necessarily integrally formed as long as the heat-generating elements can be in electrical contact with each other. For example, the heat-generating elements may be particles or fibers formed of the metals or the non-metals described above, and the electrical contact between the heat-generating elements may be formed by dispersing particle-like, mesh-like, or fibrous heat-generating elements in a resin film serving as the base material described above.

In a case where the particle-like, mesh-like, or fibrous heat-generating elements are dispersed in the resin film serving as the base material described above, the content of the resin film serving as the base material of the particle-like, mesh-like, or fibrous heat-generating elements is preferably in a range of 20% to 95% by mass and more preferably in a range of 40 to 90% by mass.

The average thickness of the planar heat-generating element is typically 1 μm or greater, preferably 2 μm or greater, more preferably 3 μm or greater, still more preferably 5 μm or greater, and particularly preferably 10 μm or greater. The average thickness of the planar heat-generating element is preferably 200 μm or less, more preferably 150 μm or less, still more preferably 100 μm or less, and particularly preferably 50 μm or less.

When the average thickness of the planar heat-generating element is in the above-described ranges, the current amount and the heat generation amount can be sufficiently obtained, the heat-generating element can be efficiently heated by resistance heating, and the followability and attaching workability of the pressure sensitive adhesive tape are excellent.

Further, the average thickness of the planar heat-generating element is an average value obtained by measuring the thicknesses of the heat-generating element at optionally selected 5 or more sites. In a case where the planar heat-generating element is disposed on one or both surfaces of the base material, the average thickness of the planar heat-generating element is the thickness excluding the thickness of the base material. Further, in a case where the heat-generating element is disposed on both surfaces of the base material, the average thickness thereof is the thickness of the heat-generating element for one surface.

In a case where the heating means is electromagnetic induction heating or thermal conduction, the shape of the heat-generating element can be appropriately selected and may be planar, mesh-like, or a shape of a resin film or a sheet obtained by dispersing particles or fibers formed of the heat-generating element at a high density. The planar heat-generating element may be molded in the form of a pattern, or may be band-like or linear. When the heat-generating element is band-like or linear, the heat generation efficiency is high and the heat-generating element is easily peeled off due to a small contact area with the adherend. The length (the band width or the line width) of the heat-generating element in the minor axis direction is preferably in a range of 1 to 10 mm and more preferably in a range of 2 to 5 mm. The average thickness of the planar heat-generating element is preferably in a range of 5 to 200 μm, more preferably in a range of 10 to 150 μm, and still more preferably in a range of 12 to 100 μm.

In a case where the heating means is infrared heating or microwave heating, the heat-generating element may be a resin film or a sheet in which particles or fibers formed of the heat-generating element are dispersed at a high density. In a case where the heating means is infrared heating, a pigment or the like may be used as an infrared absorbing material. Such a pigment may be dispersed in a resin film or a sheet, or a resin film or a sheet may be coated with the pigment.

The heat-generating element may be produced as appropriate, or a commercially available product may be used as the heat-generating element. Examples of the commercially available product include planar heat-generating elements, for example, nichrome foil, stainless steel foil, titanium foil, and nickel silver, such as “NCH1-H”, “SUS304-H”, “SUS430-H”, “TR270C-H”, and “Nickel Silver C7701” (all manufactured by TAKEUCHI METAL FOIL & POWDER CO., LTD.); and “Stainless Fiber Sheet” (manufactured by TOMOEGAWA CORPORATION). Further, products obtained by molding these heat-generating elements in the form of a pattern can also be used.

### [Pressure Sensitive Adhesive Layer]

Examples of the components constituting the pressure sensitive adhesive layer of the pressure sensitive adhesive tape according to the present invention include an acrylic pressure sensitive adhesive, a urethane-based pressure sensitive adhesive, a rubber-based pressure sensitive adhesive such as a synthetic rubber-based pressure sensitive adhesive or a natural rubber-based pressure sensitive adhesive, a silicone-based pressure sensitive adhesive, and a vinyl ether-based pressure sensitive adhesive. Among these, a pressure sensitive adhesive that can be employed as a pressure-sensitive adhesive is preferable, and an acrylic pressure sensitive adhesive containing an acrylic polymer is more preferable. The acrylic pressure sensitive adhesive containing an acrylic polymer is difficult to melt or soften when heated. Therefore, the melt-softening layer described below in the pressure sensitive adhesive tape according to the present invention can be selectively melted or softened by heat generated from the heat-generating element of the pressure sensitive adhesive according to the present invention. Further, the pressure-sensitive adhesive is an adhesive used to bond a material by applying a pressure thereto at room temperature around 20° C. for a short time, and has tackiness at a normal temperature.

Examples of the acrylic polymer include acrylic polymers such as a homopolymer of a (meth)acrylic acid ester monomer and a copolymer of a (meth)acrylic acid ester monomer and other monomers. In the present specification, the term “(meth)acryl” denotes any one or both of acryl and methacryl. The term “(meth)acrylate” denotes any one or both of acrylate and methacrylate.

Examples of the (meth)acrylic acid ester monomer include (meth)acrylic acid alkyl ester having an alkyl chain with 1 to 14 carbon atoms such as methyl (meth)acrylate, ethyl (meth)acrylate, propyl (meth)acrylate, butyl (meth)acrylate, hexyl (meth)acrylate, cyclohexyl (meth)acrylate, octyl (meth)acrylate, 2-ethylhexyl (meth)acrylate, isononyl (meth)acrylate, isodecyl (meth)acrylate, or lauryl (meth)acrylate.

The acrylic polymer may have only one or two or more kinds of these monomers as constitutional units.

The content of the (meth)acrylic acid ester monomer is preferably in a range of 70% to 99.9% by mass, more preferably in a range of 80% to 99% by mass, and still more preferably in a range of 90% to 97% by mass with respect to all components of the monomer constituting the acrylic polymer.

Further, the pressure sensitive adhesive layer may contain polar group-containing monomers as other monomers for obtaining an acrylic polymer. Examples of the polar group-containing monomers include a carboxylic acid containing an ethylenically unsaturated group such as (meth)acrylic acid, itaconic acid, itaconic anhydride, maleic acid, maleic anhydride, or crotonic acid; a (meth)acrylate containing a hydroxyl group such as 2-hydroxyethyl (meth)acrylate, hydroxypropyl (meth)acrylate, 4-hydroxybutyl (meth)acrylate, caprolactone-modified (meth)acrylate, polyoxyethylene (meth)acrylate, or polyoxypropylene (meth)acrylate; and a nitrogen-containing monomer containing an ethylenically unsaturated group such as (meth)acrylonitrile, N-vinyl-2-pyrrolidone, N-vinylcaprolactam, N-vinyl laurolactam, (meth)acryloylmorpholine, (meth)acrylamide, N, N-dimethyl (meth)acrylamide, N-methylol (meth)acrylamide, N-butoxymethyl (meth)acrylamide, N, N-dimethylaminomethyl (meth)acrylate, or 2-(perhydrophthalimide-N-yl)ethyl acrylate.

In a case where a crosslinking agent described below is used in combination, from the viewpoint that a crosslinked structure can be formed between a hydroxyl group or a carboxyl group and a crosslinking agent and the storage elastic modulus of the pressure sensitive adhesive layer can be adjusted, a (meth)acrylate containing a hydroxyl group and a carboxylic acid containing an ethylenically unsaturated group are preferable, and 2-hydroxyethyl (meth)acrylate, 4-hydroxybutyl (meth)acrylate, 6-hydroxyhexyl (meth)acrylate, and acrylic acid are more preferable as the polar group-containing monomer.

The content of the polar group-containing monomer in the acrylic polymer is preferably in a range of 0.1% to 20% by mass, more preferably in a range of 1% to 13% by mass, and still more preferably in a range of 1.5% to 8% by mass with respect to all components of the monomer constituting the acrylic polymer.

The weight-average molecular weight of the acrylic polymer is preferably in a range of 400,000 to 1,400,000, more preferably in a range of 600,000 to 1,200,000, and still more preferably in a range of 650,000 to 1,100,000. Here, the weight-average molecular weight is a weight-average molecular weight in terms of standard polystyrene measured by gel permeation chromatography (GPC).

Specifically, the weight-average molecular weight is determined under the following measurement conditions using “SC8020” (manufactured by Tosoh Corporation) as a GPC measuring device.
Sample concentration: 0.5% by mass (tetrahydrofuran solution)
Sample injection volume: 100 μL
Eluent: tetrahydrofuran (THF)
Flow rate: 1.0 mL/min
Column temperature (measurement temperature): 40° C.
Column: “TSKgel GMHHR-H” (manufactured by Tosoh Corporation)
Detector: differential refractometer

The pressure sensitive adhesive layer may further contain a tackifying resin for the purpose of adjusting the adhesiveness thereof. Examples of the tackifying resin include various tackifying resins such as a rosin-based resin, a polymerized rosin-based resin, a polymerized rosin ester-based resin, a rosin phenol-based resin, a stabilized rosin ester-based resin, a disproportionated rosin ester-based resin, a hydrogenated rosin ester-based resin, a terpene-based resin, a terpene phenol-based resin, a petroleum-based resin, C₅/C₉ petroleum-based resins, and a (meth)acrylate-based resin. Further, processed oil, a polyester-based tackifying resin, and a tackifying resin in a liquid state at room temperature, for example, liquid rubber with a low molecular weight such as polybutene can also be used.

In a case where the pressure sensitive adhesive layer contains a tackifying resin, the amount thereof is preferably in a range of 1 to 150 parts by mass and more preferably in a range of 10 to 150 parts by mass with respect to 100 parts by mass of the base resins such as an acrylic polymer and the like constituting the pressure sensitive adhesive layer from the viewpoint of enhancing the adhesiveness at around room temperature (0° C. to 40° C.) and exhibiting thermal durability. Further, in a case where the pressure sensitive adhesive layer contains a tackifying resin, the total content of the base resins and the tackifying resin in the pressure sensitive adhesive forming the pressure sensitive adhesive layer is preferably 50% by mass or greater, more preferably 70% by mass or greater, and still more preferably 90% by mass or greater with respect to the total amount of the solid content of the tackifying agent.

The pressure sensitive adhesive layer may further contain a crosslinking agent for the purpose of improving the cohesive strength. Examples of the crosslinking agent include known crosslinking agents such as isocyanate-based, epoxy-based, aziridine-based, polyvalent metal salt-based, metal chelate-based, keto hydrazide-based, oxazoline-based, carbodiimide-based, silane-based, and glycidyl (alkoxy) epoxy silane-based crosslinking agents.

The pressure sensitive adhesive layer may further contain other additives within a range where the effects of the present invention are not impaired, such as an antioxidant, an anti-aging agent, a colorant such as a pigment or a dye, a thickener, a leveling agent, a film-forming assistant, an infrared absorbing agent, an ultraviolet absorbing agent, and a water repellent.

The pressure sensitive adhesive layer may further contain a thermoplastic resin, and it is preferable that the pressure sensitive adhesive layer be formed of a component that is difficult to melt or soften when heated, which is different from the thermoplastic resin contained in the melt-softening layer from the viewpoint that the melt-softening layer is selectively melt or softened by the heat generated from the heat-generating element in the pressure sensitive adhesive tape according to the present invention. More specifically, it is preferable that the pressure sensitive adhesive layer contain a thermoplastic resin in which the temperature at which the loss tangent (tan δ) of the pressure sensitive adhesive layer is 0.8 or greater is higher than the temperature at which the loss tangent (tan δ) of the component containing the thermoplastic resin, other than the inorganic hollow filler, constituting the melt-softening layer described below is 0.8 or greater, for example, at a temperature of 40° C. or higher.

Further, in the present specification, “component containing the thermoplastic resin, other than the inorganic hollow filler, constituting the melt-softening layer” will also be simply referred to as “melt-softening resin composition” hereinafter. The details of the melt-softening resin composition will be described below.

From the viewpoints of adhesion retention power with the adherend and film uniformity during application of a solution, the thickness of the pressure sensitive adhesive layer is preferably in a range of 10 to 200 μm and more preferably in a range of 20 to 100 μm. Further, the thickness of the pressure sensitive adhesive layer is an average value obtained by measuring the thicknesses thereof at optional five sites.

It is preferable that the melting point of the pressure sensitive adhesive layer be higher than the melting point of the melt-softening layer. Here, “melting point of the pressure sensitive adhesive layer” denotes the melting point of the composition (hereinafter, simply referred to as “pressure sensitive adhesive layer composition”) formed of an acrylic pressure sensitive adhesive, a urethane-based pressure sensitive adhesive, a rubber-based pressure sensitive adhesive, a silicone-based pressure sensitive adhesive, a vinyl ether-based pressure sensitive adhesive constituting the pressure sensitive adhesive layer, and as necessary, a tackifying resin, a crosslinking agent, other additives, and a thermoplastic resin different from the thermoplastic resin contained in the melt-softening layer. The melting point of the pressure sensitive adhesive layer (pressure sensitive adhesive layer composition) is, for example, preferably 130° C. or higher and more preferably in a range of 130° C. to 200° C. The melt-softening layer can be melted or softened by the heat generated from the heat-generating element before the pressure sensitive adhesive layer is melted or softened, by adjusting the melting point of the pressure sensitive adhesive layer to be in the above-described ranges and adjusting the melting point of the melt-softening layer to be in the ranges described below. That is, when the article configured to be bonded by the pressure sensitive adhesive tape of the present invention is thermally dismantled, the melt-softening layer can be stably and preferentially melted and softened so that the article can be easily dismantled.

Further, “melting point of the pressure sensitive adhesive layer” is a temperature of the endothermic peak accompanied by the melting of the pressure sensitive adhesive layer (pressure sensitive adhesive composition), which is measured by differential scanning calorimetry (DSC).

It is preferable that the temperature at which the tan δ of the pressure sensitive adhesive layer (pressure sensitive adhesive layer composition) is 0.8 or greater be higher than the temperature at which the tan δ of the component containing the thermoplastic resin, other than the inorganic hollow filler, constituting the melt-softening layer is 0.8 or greater, at a temperature of 40° C. or higher. Here, it is more preferable that the temperature at which the tan δ of the pressure sensitive adhesive layer (pressure sensitive adhesive layer composition) is 0.8 or greater be higher than the temperature at which the tan δ of the melt-softening resin composition is 1 or greater.

Specifically, at a temperature of 40° C. or higher, the temperature at which the tan δ of the pressure sensitive adhesive layer (pressure sensitive adhesive layer composition) is 0.8 is preferably higher than the temperature at which the tan δ of the melt-softening resin composition is 0.8, more preferably higher than the temperature at which the tan δ of the melt-softening resin composition is 1, and still more preferably higher than the temperature at which the tan δ of the melt-softening resin composition is 1.2.

According to a preferable aspect of the pressure sensitive adhesive layer (pressure sensitive adhesive layer composition), the maximum value of the tan δ in a temperature range of 80° C. to 160° C. is preferably less than 1, more preferably less than 0.8, and still more preferably 0.6 or less. From the viewpoint that the pressure sensitive adhesive layer can exhibit viscosity and elasticity, the tan δ of the pressure sensitive adhesive layer (pressure sensitive adhesive layer composition) in a temperature range of 80° C. to 160° C. is preferably 0.2 or greater.

As one of preferable aspects of the pressure sensitive adhesive layer, the temperature at which the tan δ of the pressure sensitive adhesive layer (pressure sensitive adhesive layer composition) is 0.8 or greater is preferably higher than 150° C. and more preferably 170° C. or higher. The upper limit of the temperature range is not particularly limited, but can be set to, for example, 300° C. and preferably 250° C.

In the pressure sensitive adhesive tape of the present invention, in a case where the pressure sensitive adhesive layer has such physical properties, the melting and/or softening of the pressure sensitive adhesive layer can be suppressed when the pressure sensitive adhesive layer and the melt-softening layer receive the same amount of heat from the heat-generating element. That is, when the article configured to be bonded by the pressure sensitive adhesive tape of the present invention is thermally dismantled, the melt-softening layer can be stably and preferentially melted and softened while the melting or softening of the pressure sensitive adhesive layer is suppressed, and thus the article can be easily dismantled in a short time.

Further, from the viewpoint of exhibiting satisfactory adhesiveness to the adherend before and after dismantling, the tan δ of the pressure sensitive adhesive layer (pressure sensitive adhesive layer composition) at 23° C. is preferably in a range of 0.1 to 0.8 and more preferably in a range of 0.2 to 0.6.

The tan δ of the pressure sensitive adhesive layer (pressure sensitive adhesive layer composition) is determined by dynamic viscoelasticity measurement at a frequency of 1 Hz. For example, a test piece of the pressure sensitive adhesive layer composition with a dry thickness of about 2 mm is prepared, and a storage elastic modulus G′ and a loss elastic modulus (G″) are measured under conditions of a temperature range of −40° C. to 200° C. and a temperature increase rate of 2° C./min at a frequency of 1 Hz using a viscoelasticity tester (ARES-G2, manufactured by TA Instruments Japan Inc.). The tan δ is determined according to the calculation formula [tan δ=G″/G′].

The tan δ of the pressure sensitive adhesive layer (pressure sensitive adhesive layer composition) can be adjusted by the base polymers of the pressure sensitive adhesive serving as main components, for example, monomer species constituting the acrylic polymer described above, the combination and the blending ratio of each monomer, the blending amount of the tackifying resin to be added as necessary, and the amount of the crosslinking agent to be added (gel fraction) as necessary.

### [Melt-Softening Layer]

The melt-softening layer constituting the pressure sensitive adhesive tape according to the present invention contains a thermoplastic resin and an inorganic hollow filler.

### <Inorganic Hollow Filler>

Examples of the inorganic hollow filler include hollow fillers formed of metal oxide ceramics such as alumina, silica, silica alumina, zirconia, and magnesia; non-oxide ceramics such as silicon carbide, boron carbide, nitrogen carbide, aluminum nitride, silicon nitride; and boron nitride, and inorganic materials such as glass, calcium carbonate, volcanic ash (shirasu), and fly ash. These may be used alone or in combination of two or more kinds thereof. The inorganic hollow filler may be subjected to a surface treatment such as hydrophobization with a silane coupling agent or a fluorine-based compound.

Among these, from the viewpoint that the melt-softening layer constituting the pressure sensitive adhesive tape of the present invention maintains properties such as the adhesive strength, the shear strength, and the holding strength, the melt-softening layer exhibits the heat insulation effect of suppressing conduction of heat generated from the heat-generating element to the adherend, and the melt-softening layer can further exhibit the heat storage effect, at least one or more inorganic hollow fillers selected from the group consisting of a glass hollow filler and a silica hollow filler are preferable, and a glass hollow filler is more preferable.

The inorganic hollow filler formed of glass is commercially available, and examples thereof include “Glass Bubbles” Series (trade name, manufactured by 3M Company), “Q-CEL (registered trademark)” Series and “Sphericel (registered trademark)” Series (both manufactured by Potters-Ballotini Co., Ltd.), and “Glass Balloon” (trade name, manufactured by TOMOE Engineering Co., Ltd.).

From the viewpoint of easily maintaining the strength of the melt-softening layer in a bonded state or easily enhancing the heat storage effect of the melt-softening layer, the particle diameter (average particle diameter) of the inorganic hollow filler is preferably less than or equal to the thickness of the melt-softening layer, preferably in a range of 1 to 500 μm, more preferably in a range of 1 to 200 μm, still more preferably in a range of 5 to 200 μm, even still more preferably in a range of 10 to 100 μm, and even still more preferably in a range of 10 to 80 μm.

Further, the particle diameter of the inorganic hollow filler is a value of the median diameter (D50) measured by a laser diffraction/scattering particle size distribution measuring device.

From the viewpoint of enhancing the dispersibility of the inorganic hollow filler in the melt-softening layer or from the viewpoint that the mass of the pressure sensitive adhesive tape of the present invention is not excessively increased, the specific gravity (true density) of the inorganic hollow filler is typically preferably in a range of 0.01 to 1.8 g/cm³ and more preferably in a range of 0.02 to 1.5 g/cm³.

The blending amount of the inorganic hollow filler is typically preferably in a range of 5% to 80% by volume and more preferably in a range of 10% to 65% by volume with respect to the total volume of the melt-softening layer. Further, the blending amount of the inorganic hollow filler is typically preferably in a range of 0.1% to 80% by mass and more preferably in a range of 1.0% to 70% by mass with respect to the total mass of the melt-softening layer. It is advantageous that the blending amount of the inorganic hollow filler in the melt-softening layer is in the above-described ranges in terms that the heat insulation effect of the melt-softening layer can be increased and the melt-softening layer can further exhibit the heat insulation effect.

A filler that is unlikely to expand or foam when heated and has a volume that does not substantially increase when heated is preferable as the inorganic hollow filler, and the expansion rate (volume ratio) when the filler is heated at 120° C. to 160° C. for 5 minutes is preferably 1.5 times or less and more preferably 1.2 times or less.

### <Thermoplastic Resin>

Examples of the thermoplastic resin include a crystalline or non-crystalline polyester-based resin such as a urethane-based resin, polycarbonate, a vinyl chloride-based resin, an acrylic resin, or polyethylene terephthalate, a polyamide-based resin, a styrene-based resin, an olefin-based resin, a cellulose-based resin, a silicone-based resin, a fluorine-based resin, a styrene-based thermoplastic elastomer, an olefin-based thermoplastic elastomer, a vinyl chloride-based thermoplastic elastomer, an acrylic thermoplastic elastomer, a urethane-based thermoplastic elastomer, an ester-based thermoplastic elastomer, and an amide-based thermoplastic elastomer. There may be used alone or in combination of two or more kinds thereof.

From the viewpoint that the melt-softening layer can be melted or softened by the heat generated from the heat-generating element of the pressure sensitive adhesive tape according to the present invention and the melt-softening layer can be melted or softened without containing a component that generates a peeling starting point at an adhesive interface and a component for causing a decrease in adhesive strength, such as a heat foaming agent so that the pressure sensitive adhesive tape can be peeled off and preferably from the viewpoint of being advantageous in terms that the melt-softening layer has a softening point, is drastically flexible when having a temperature higher than the softening point, and exhibits high deformability and fluidity, among the examples described above, a urethane-based resin, an acrylic resin, a polyester-based resin, a styrene-based thermoplastic elastomer, an olefin-based thermoplastic elastomer, a vinyl chloride thermoplastic elastomer, an acrylic thermoplastic elastomer, a urethane-based thermoplastic elastomer, an ester-based thermoplastic elastomer, or an amide-based thermoplastic elastomer is preferable, and a styrene-based thermoplastic elastomer is more preferable as the thermoplastic resin.

As the styrene-based thermoplastic elastomer, a block copolymer formed of a polymer block having a structural unit derived from an aromatic vinyl compound and a polymer block having a structural unit derived from a conjugated diene compound or a hydrogenated product thereof is preferable. Specific examples thereof include a hydrogenated product obtained by hydrogenating an ethylenic double bond of a styrene-based random copolymer such as a polystyrene-polybutadiene diblock copolymer or a polystyrene-poly (ethylene-butylene) diblock copolymer (SEB) which is a hydrogenated product thereof, a polystyrene-polybutadiene-polystyrene triblock copolymer (SBS) or a polystyrene-poly (ethylene-butylene)-polystyrene triblock copolymer (SEBS) which is a hydrogenated product thereof, a polystyrene-polyisoprene diblock copolymer or a polystyrene-poly (ethylene-propylene) diblock copolymer (SEP) which is a hydrogenated product thereof, a polystyrene-polyisoprene-polystyrene triblock copolymer (SIS) or a polystyrene-poly (ethylene-propylene)-polystyrene triblock copolymer (SEPS) which is a hydrogenated product thereof, a polystyrene-polybutadiene-polystyrene-polybutadiene tetrablock copolymer (SBSB) or a hydrogenated product thereof, a polystyrene-polybutadiene-polystyrene-polybutadiene-polystyrene pentablock copolymer (SBSBS), a styrene-based multiblock copolymer, or styrene-butadiene rubber (SBR).

Further, a commercially available product may be used as the styrene-based thermoplastic elastomer.

The weight-average molecular weight of the styrene-based thermoplastic elastomer is preferably in a range of 10,000 to 800,000, more preferably in a range of 30,000 to 500,000, and still more preferably in a range of 50,000 to 300,000. When the weight-average molecular weight thereof is in the above-described ranges, the storage elastic modulus and the loss tangent of the melt-softening layer are easily adjusted to be in a desirable range, and the melt-softening layer is easily melted or softened when heated. Further, the weight-average molecular weight of the styrene-based thermoplastic elastomer is determined in the same manner as the method of measuring the weight-average molecular weight of the acrylic polymer described above.

The styrene-based thermoplastic elastomer may be used alone or in combination of two or more kinds thereof. That is, the styrene-based thermoplastic elastomer may be formed of one or two or more kinds of triblock copolymers, one or two or more kinds of diblock copolymers, or a mixture of a triblock copolymer and a diblock copolymer.

Among these, from the viewpoint that the melt-softening layer exhibits appropriate cohesive strength, has satisfactory adhesive strength at around room temperature (0° C. to 40° C.) before being heated, and can be easily melted or softened when heated, it is preferable that the styrene-based thermoplastic elastomer contain at least a diblock copolymer. The content of the diblock copolymer in the styrene-based thermoplastic elastomer is preferably in a range of 10% to 100% by mass, more preferably in a range of 10% to 90% by mass, and still more preferably in a range of 15% to 80% by mass. Further, from the viewpoint that the balance between the adhesiveness at 20° C. and the meltability when the melt-softening layer is heated is excellent, the content thereof is particularly preferably in a range of 20% to 75% by mass.

Since the melt-softening layer is melted or softened by the heat generated from the heat-generating element, the adhesive strength during heating is weaker than the adhesive strength at around room temperature (0° C. to 40° C.).

The content proportion of the thermoplastic resin in the melt-softening layer is preferably in a range of 30% to 95% by mass and more preferably in a range of 35% to 90% by mass with respect to the total amount of the melt-softening layer. It is advantageous that the blending amount of the thermoplastic resin into the melt-softening layer is in the above-described ranges in terms of the coating properties of the melt-softening layer and controlling the melt-softening temperature.

### <Optional Components>

The melt-softening layer may contain an organic hollow filler that does not expand or foam when heated in addition to the inorganic hollow filler described above. The organic hollow filler has a hollow structure in which the shell is formed of a resin and the core portion is hollow. Examples of such an organic hollow filler that does not expand or foam when heated include expanded organic hollow fillers and foamed organic hollow fillers. Such an organic hollow filler is also capable of exhibiting the heat storage effect of the melt-softening layer and the heat insulation effect of suppressing conduction of heat generated from the heat-generating element to the adherend similarly to the inorganic hollow filler described above. Further, the organic hollow filler that does not expand or foam when heated is an organic hollow filler having a volume that does not substantially increase when the, and the expansion rate (volume ratio) when the filler is heated at 120° C. to 160° C. for 5 minutes is preferably 1.5 times or less and more preferably 1.2 times or less.

Examples of the resin constituting the organic hollow filler include resins having constitutional units derived from acrylonitrile, vinyl chloride, vinylidene chloride, styrene, vinyl acetate, ethylene, and (meth)acrylic acid ester. Examples thereof include an acrylonitrile-based polymer, a vinylidene chloride-based polymer, an acrylic polymer, a styrene-based polymer, and a polyethylene-based polymer.

It is preferable that the organic hollow filler which can be contained in the melt-softening layer be a filler that does not expand or foam when heated, but the melt-softening layer may contain a small amount of an organic hollow filler that expands or foams when heated (a thermally expandable organic hollow filler or thermally foamable organic hollow filler) within a range where the effects of the present invention are not impaired. The melt-softening layer may be substantially free of the organic hollow filler that expands or foams when heated. The expression “substantially free” denotes that the amount of the thermally expandable organic hollow filler or the thermally foamable organic hollow filler is less than 10 parts by mass, preferably 5 parts by mass or less, more preferably 1 part by mass or less, still more preferably 0.5 parts by mass or less, and particularly preferably 0 parts by mass with respect to 100 parts by mass of the melt-softening layer resin composition.

The melt-softening layer may further contain a tackifying resin for the purpose of adjusting the adhesiveness thereof. The details of the tackifying resin are the same as the details of the tackifying resin described in the section of the pressure sensitive adhesive layer.

The melt-softening layer may further contain a crosslinking agent for the purpose of improving the cohesive strength. The details of the crosslinking agent are the same as the details of the crosslinking agent described in the section of the pressure sensitive adhesive layer.

The melt-softening layer may further contain other additives within a range where the effects of the present invention are not impaired, such as an antioxidant, an anti-aging agent, a colorant such as a pigment or a dye, a thickener, a leveling agent, a film-forming assistant, an infrared absorbing agent, an ultraviolet absorbing agent, and a water repellent.

In a case where the melt-softening layer contains a tackifying resin, the amount thereof is preferably in a range of 1 to 150 parts by mass and more preferably in a range of 10 to 150 parts by mass with respect to 100 parts by mass of the thermoplastic resin constituting the melt-softening layer from the viewpoint of enhancing the adhesiveness at around room temperature (0° C. to 40° C.) and exhibiting thermal durability. Further, in a case where the melt-softening layer contains a tackifying resin, the total content of the thermoplastic resin and the tackifying resin constituting the melt-softening layer is preferably in a range of 20% to 99.9% % by mass and more preferably in a range of 30% to 99.0% by mass with respect to the total mass of all components constituting the melt-softening layer, that is, the inorganic hollow filler, the thermoplastic resin, the tackifying resin, and the crosslinking agent and other additives to be optionally contained.

### <Physical Properties of Melt-Softening Layer>

The melting point of the melt-softening layer is preferably lower than the melting point of the pressure sensitive adhesive layer described above. Specifically, the melting point thereof is preferably in a range of 80° C. to 200° C., more preferably in a range of 90° C. to 180° C., and still more preferably in a range of 100° C. to 160° C. Here, “melting point of the melt-softening layer” denotes the melting point of the composition (that is, the melt-softening resin composition) formed of the components containing the thermoplastic resin, other than the inorganic hollow filler, constituting the melt-softening layer. In other words, the melt-softening resin composition is a composition formed of the thermoplastic resin constituting the melt-softening layer, excluding the inorganic hollow filler, and the tackifying resin, the crosslinking agent, and other additives to be further contained as necessary. Accordingly, “melting point of the melt-softening layer” denotes the melting point of such a melt-softening resin composition.

When the melting point of the melt-softening layer is in the above-described ranges, the pressure sensitive adhesive tape of the present invention can exhibit high adhesive strength before being heated. In addition, when the article configured to be bonded by the pressure sensitive adhesive tape of the present invention is thermally dismantled, the melt-softening layer can be stably and preferentially melted and softened even in a case where the amount of heat generated from the heat-generating element is small, and thus the article can be easily dismantled in a short time.

Further, “melting point of the melt-softening layer” is a temperature of the endothermic peak accompanied by the melting of the melt-softening resin composition, which is measured by differential scanning calorimetry (DSC).

The storage elastic modulus G23 of the melt-softening resin composition at 23° C. described above is preferably in a range of 1.0×10³ Pa to 1.0×10⁹ Pa, more preferably in a range of 1.0×10³ Pa to 5.0×10⁷ Pa, still more preferably in a range of 5.0×10³ Pa to 5.0×10⁷ Pa, even still more preferably in a range of 5.0×10³ Pa to 1.0×10⁶ Pa, and particularly preferably 5.0×10³ Pa to 1.0×10⁶ Pa from the viewpoint of satisfactorily fixing adherends to each other at around room temperature (0° C. to 40° C.).

The storage elastic modulus G120 of the melt-softening resin composition at 120° C. is preferably in a range of 1.0×10⁰ Pa to 5.0×10⁶ Pa, more preferably in a range of 1.0×10³ Pa to 1.0×10⁶ Pa, still more preferably in a range of 1.0×10³ Pa to 1.0×10⁶ Pa, and even still more preferably in a range of 5.0×10³ Pa to 5.0×10⁵ Pa from the viewpoint of easily separating the adherends from each other by heating the pressure sensitive adhesive tape. When the storage elastic modulus G120 is in the above-described ranges, the melt-softening layer can be melted and softened in a short time when heated so that the melt-softening layer can be peeled off.

Further, the tan δ of the melt-softening resin composition at a temperature of 80° C. or higher (preferably the tan δ at a temperature of 100° C. or higher) is preferably 0.8 or greater and more preferably 1 or greater.

According to a suitable aspect for the melt-softening layer, it is preferable that the temperature at which the tan δ of the melt-softening resin composition is 0.8 or greater be lower than the temperature at which the tan δ of the pressure sensitive adhesive layer (pressure sensitive adhesive layer composition) is 0.8 or greater.

Specifically, the temperature at which the tan δ of the melt-softening resin composition is 0.8 or greater is, for example, preferably 80° C. or higher, more preferably 80° C. or higher and 200° C. or lower, still more preferably 100° C. or higher and 160° C. or lower, and even still more preferably 100° C. or higher and 130° C. or lower.

More specifically, the temperature at which the tan δ of the melt-softening resin composition is 0.8 is preferably 80° C. or higher, more preferably 80° C. or higher and 200° C. or lower, and still more preferably 100° C. or higher and 160° C. or lower.

Further, the temperature at which the tan δ of the melt-softening resin composition is 1 is preferably 80° C. or higher, more preferably 80° C. or higher and 200° C. or lower, still more preferably 100° C. or higher and 180° C. or lower, and even still more preferably 100° C. or higher and 130° C. or lower.

A difference between the temperature at which the tan δ of the melt-softening resin composition is 0.8 (more preferably the temperature at which the tan δ thereof is 1) and the temperature at which the tan δ of the pressure sensitive adhesive layer (pressure sensitive adhesive layer composition) is 0.8 (more preferably the temperature at which the tan δ thereof is 1) may be a difference in temperature at which the melt-softening layer is preferentially melted or softened by the heat received from the heat-generating element, and is, for example, 10° C. or higher, preferably 25° C. or higher, still more preferably 30° C. or higher, and even still more preferably 50° C. or higher.

In a case where the melt-softening resin composition in the pressure sensitive adhesive tape of the present invention has the above-described physical properties, the melt-softening layer is likely to be preferentially melted or softened when the pressure sensitive adhesive layer and the melt-softening layer receive the same amount of heat from the heat-generating element. When the melt-softening layer is in a desired dismantling temperature range by the heat generated from the heat-generating element, plastic deformation is likely to occur due to the melting or softening of the melt-softening layer, and the cohesive failure in the melt-softening layer can cause peeling in the melt-softening layer or at the interface between a layer adjacent to the melt-softening layer and the adherend. That is, when the article configured to be bonded by the pressure sensitive adhesive tape of the present invention is thermally dismantled, the melt-softening layer can be stably and preferentially melted and softened so that the article can be easily dismantled in a short time.

Further, from the viewpoint of enhancing the adhesiveness before dismantling, the tan δ of the melt-softening resin composition at 23° C. is preferably in a range of 0.1 to 0.8 and more preferably in a range of 0.2 to 0.6.

The storage elastic modulus G and the tan δ of the components (melt-softening resin composition) containing the thermoplastic resin, other than the inorganic hollow filler, constituting the melt-softening layer are determined by dynamic viscoelasticity measurement. For example, a test piece of the melt-softening resin composition with a dry thickness of about 2 mm is prepared, and a storage elastic modulus G′ and a loss elastic modulus (G″) at each temperature are measured under conditions of a temperature range of −40° C. to 200° C. and a temperature increase rate of 2° C./min at a frequency of 1 Hz using a viscoelasticity tester (ARES-G2, manufactured by TA Instruments Japan Inc.). The tan δ is determined according to the calculation formula [tan δ=G″/G′].

The storage elastic modulus G23, the storage elastic modulus G120, the tan δ, and the melting point of the melt-softening resin composition can be adjusted by the kind and the combination of the thermoplastic resins, the blending amount of the tackifying resin to be added as necessary, the amount of the crosslinking agent to be added as necessary, and the like.

The thermal conductivity of the melt-softening layer is preferably in a range of 0.03 to 0.20 W/m·K, more preferably in a range of 0.03 to 0.18 W/m·K, and still more preferably in a range of 0.05 to 0.15 W/m·K. When the thermal conductivity thereof is in the above-described ranges, since the heat generated from the heat-generating element is not transferred to the adherend and is likely to be stored in the melt-softening layer, the melt-softening layer can be melted and softened in a short time, and thus the article can be easily dismantled.

Further, the thermal conductivity of the melt-softening layer can be measured, for example, by a rapid thermal conductivity meter (“QTM-710”, manufactured by Kyoto Electronics Manufacturing Co., Ltd.).

From the viewpoints of the coating properties, the adhesion retention power with the adherend, and the dismantling properties, the thickness of the melt-softening layer can be set to 500 μm or less, preferably in a range of 10 to 200 μm, and more preferably in a range of 20 to 150 μm. Further, the thickness of the melt-softening layer is an average value obtained by measuring the thicknesses thereof at optional five sites.

The pressure sensitive adhesive tape of the present invention has at least one melt-softening layer adjacent to the heat-generating element, and may include a melt-softening layer c1 adjacent to one surface of a layered heat-generating element and a melt-softening layer c2 adjacent to the other surface of the heat-generating element. The specific layer configuration of the pressure sensitive adhesive tape including two melt-softening layers will be described below.

### [Layer Configuration of Pressure Sensitive Adhesive Tape]

A first aspect of the pressure sensitive adhesive tape of the present invention may be an aspect in which a pressure sensitive adhesive tape 10 includes a planar heat-generating element b, a pressure sensitive adhesive layer a disposed on one surface side of the planar heat-generating element b, and a met-softening layer c disposed on the other surface side of the planar heat-generating element b to form a laminate in which the pressure sensitive adhesive layer a, the heat-generating element b, and the melt-softening layer c are laminated in this order as shown in FIGS. 1 and 2. The melt-softening layer c adjacent to the heat-generating element b is melted or softened by the heat generated from the heat-generating element b so that the adhesive strength is decreased, and thus the pressure sensitive adhesive tape can be peeled off.

It is preferable that the planar heat-generating element b have a pair of exposed extending portions e extending from the outer peripheries of the pressure sensitive adhesive layer a and the melt-softening layer c in plan view (see FIGS. 3 and 4-1 to 4-9). The extending portions e may be provided independently at two or more sites, the positions thereof in the heat-generating element are not particularly limited and can be selected as appropriate depending on the purpose thereof, and the extending portions e at two sites may be positioned on the same side of the outer periphery of the pressure sensitive adhesive layer a and the melt-softening layer c (see FIGS. 4-1 to 4-3) or may be separately positioned at two different sides (see FIGS. 3 and 4-4 to 4-6).

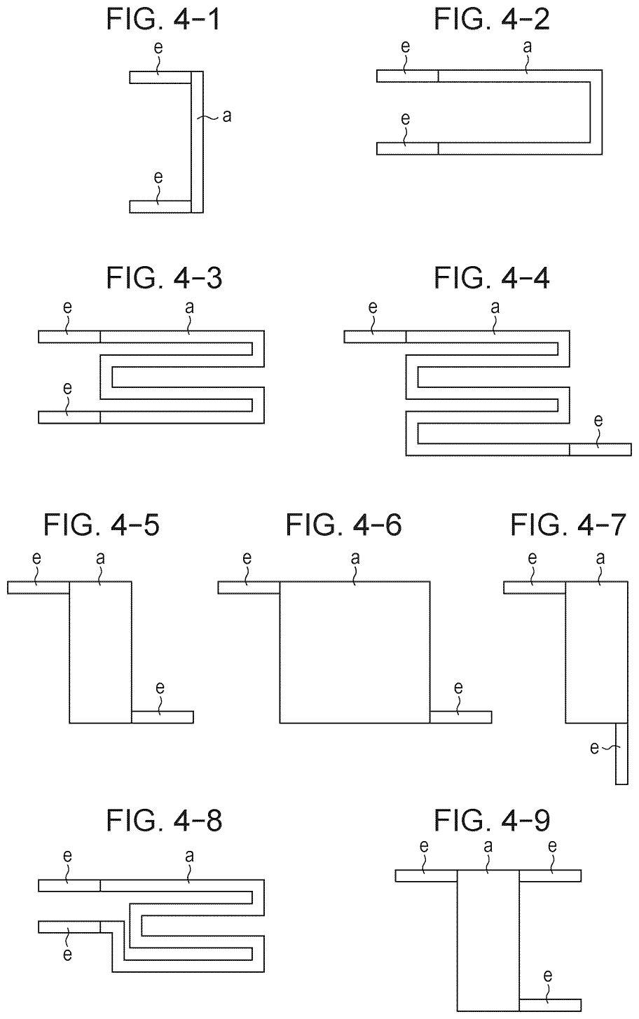

It is preferable that the extending portions e be separately positioned on two sides opposite to each other on the outer peripheries of the pressure sensitive adhesive layer a and the melt-softening layer c (see FIGS. 4-4 to 4-6) and that the extending portions e be separately positioned on approximate diagonal lines in the outer peripheries of the pressure sensitive adhesive layer a and the melt-softening layer c (see FIGS. 4-2 to 4-7). Further, in a case where the extending portions e are positioned on the same side in the outer peripheries of the pressure sensitive adhesive layer a and the melt-softening layer c, it is preferable that the heat-generating element b have a U-shape, a zigzag shape, or the like in plan view (see FIGS. 4-1 to 4-4 and 4-8), and the extending portions e may be positioned on positions close to each other on the same side when the heat-generating element b can uniformly heat the surfaces of the pressure sensitive adhesive layer a and the melt-softening layer c (see FIGS. 4-3 and 4-8).

In this manner, the current can flow in the entire area of the planar heat-generating element b, and thus the heat generation efficiency is further enhanced.

The extending portions e may be provided at three or more sites (see FIG. 4-9), and a desired pair of extending portions (two sites) may be appropriately selected and electrically conducted to the heat-generating element. A pair of extending portions e of the heat-generating element b function as a pair of terminals for electrical connection with the power source in a method of dismantling an article described below, and can be easily electrically conducted to the heat-generating element b.

From the viewpoint of ease of contact with the power source or the heat-generating source, the length of the extending portion is preferably in a range of 1 to 50 mm and more preferably in a range of 2 to 25 mm. Each extending portion may be bent in a direction different from the plane direction of the pressure sensitive adhesive tape. For example, the extending portion is bent in a direction perpendicular to the plane direction of the pressure sensitive adhesive tape and stored when adherends are in a bonded state, and the extending portion is bent again in the plane direction and brought into contact with the power source or the heat-generating source when the bonding between the adherends is intended to be released (dismantled).

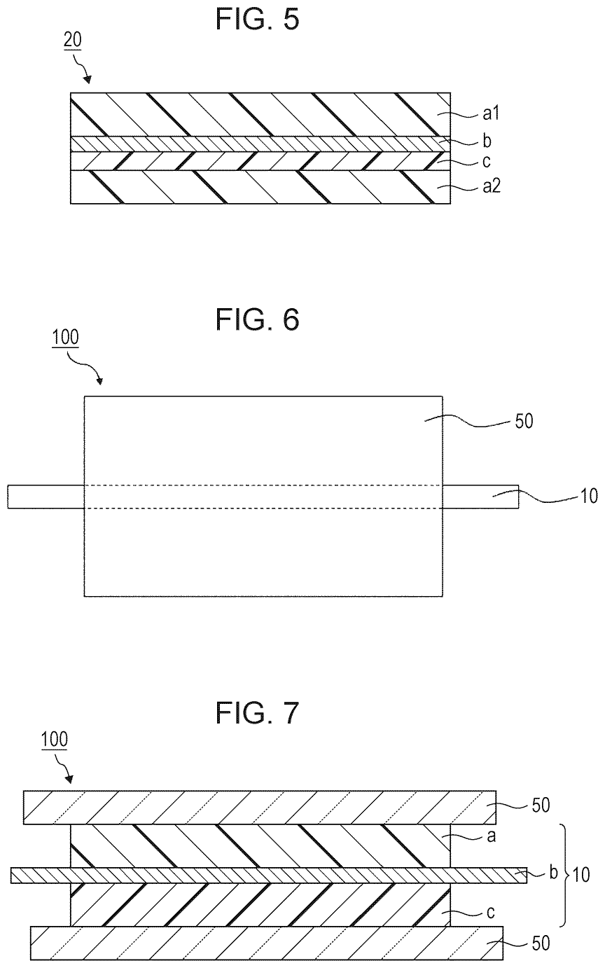

A second aspect of the pressure sensitive adhesive tape according to the present invention may be an aspect in which a pressure sensitive adhesive tape 20 is a laminate formed by laminating a pressure sensitive adhesive layer a1, the heat-generating element b, the melt-softening layer c, and a pressure sensitive adhesive layer a2 in this order as shown in FIG. 5. Alternatively, an aspect in which the pressure sensitive adhesive tape 20 is a laminate formed by laminating the pressure sensitive adhesive layer a1, the melt-softening layer c1, the heat-generating element b, and the melt-softening layer c2 in this order may be employed, and in this case, the pressure sensitive adhesive layer a2 may be further provided on a side of the melt-softening layer c2 opposite to the side where the heat-generating element b is provided.

That is, examples of the second aspect of the pressure sensitive adhesive tape according to the present invention include a laminate having the heat-generating element b, the pressure sensitive adhesive layer a1 disposed on one surface of the heat-generating element b, the melt-softening layer c disposed on the other surface of the heat-generating element b, and the pressure sensitive adhesive layer a2 disposed on a surface different from the surface of the melt-softening layer c adjacent to the heat-generating element b. Further, other examples of the second example include a laminate having the heat-generating element b, the melt-softening layer c1 and the melt-softening layer c2 that are disposed on both surfaces of the heat-generating element b, the pressure sensitive adhesive layer a1 disposed on the surface different from the surface of the melt-softening layer c1 adjacent to the heat-generating element b, and the pressure sensitive adhesive layer a2 disposed on the surface different from the surface of the melt-softening layer c2 adjacent to the heat-generating element b.

The melt-softening layer c1 or c2 adjacent to the heat-generating element b is melted or softened by the heat generated from the heat-generating element b so that the adhesive strength is decreased, and thus the pressure sensitive adhesive tape can be peeled off. The pressure sensitive adhesive tape of the present invention according to the second aspect described above, in which the pressure sensitive adhesive layer is further provided on the surface (opposite surface) of the melt-softened layer different from the surface adjacent to the heat-generating element, can increase the initial adhesive strength, and thus the rate of decrease in adhesive strength due to heating is increased.

It is preferable that the planar heat-generating element b have a pair of exposed extending portions extending from the outer peripheries of the pressure sensitive adhesive layer a1, the pressure sensitive adhesive layer a2, and the melt-softening layer c in plan view. The details of the extending portion are the same as the details of the extending portion of the planar heat-generating element b according to the first aspect.

The pressure sensitive adhesive tape of the present invention may include a peeling layer (also referred to as a peeling sheet or a release liner). Examples of the peeling layer include paper obtained by laminating a film, such as glassine paper, kraft paper, clay-coated paper, or polyethylene, paper coated with a resin such as polyvinyl alcohol or an acrylic acid ester copolymer, and a synthetic resin film coated with a fluorine resin or a silicone resin, such as polyester or polypropylene. The peeling layer may be provided on one surface or both surfaces of the pressure sensitive adhesive tape according to the present invention.

The pressure sensitive adhesive tape of the present invention may include other layers such as functional layers having functions of insulating properties, heat-insulating properties, heat-shielding properties, and the like, such as an insulating layer and a heat-insulating layer (for example, a foamed resin layer, a hollow-containing layer, and a hollow particle-containing layer) in addition to the pressure sensitive adhesive layer, the heat-generating element, and the melt-softening layer, as long as the outermost layers (excluding the peeling layer) positioned opposite to each other in the thickness direction each have an adhesive surface that can be bonded to the adherend.

In the pressure sensitive adhesive tape according to the present invention, the pressure sensitive adhesive layer a and the melt-softening layer c according to the first aspect described above may be adhesive surfaces bonded to the adherend, and the pressure sensitive adhesive layer a1 and the pressure sensitive adhesive layer a2 according to the second aspect described above may be adhesive surfaces bonded to the adherend. According to the second aspect, the initial adhesive strength can be further increased.

The pressure sensitive adhesive tape of the present invention can have the following exemplary configurations, but the present invention is not limited thereto. In the laminate configurations described below, “/” denotes the laminate interface. For example, “layer A/layer B” denotes that the layer A and the layer B are adjacent to each other, that is, in direct contact with each other.
Peeling layer/pressure sensitive adhesive layer a/heat-generating element b/melt-softening layer c
Pressure sensitive adhesive layer a/heat-generating element b/melt-softening layer c/peeling layer
Peeling layer/pressure sensitive adhesive layer a/heat-generating element b/melt-softening layer c/peeling layer
Pressure sensitive adhesive layer a/functional layer/heat-generating element b/melt-softening layer c/peeling layer
Peeling layer/pressure sensitive adhesive layer a/functional layer/heat-generating element b/melt-softening layer c/peeling layer
Peeling layer/pressure sensitive adhesive layer a/heat-generating element b/melt-softening layer c/pressure sensitive adhesive layer a
Pressure sensitive adhesive layer a/heat-generating element b/melt-softening layer c/pressure sensitive adhesive layer a/peeling layer
Peeling layer/pressure sensitive adhesive layer a/heat-generating element b/melt-softening layer c/pressure sensitive adhesive layer a/peeling layer
Peeling layer/pressure sensitive adhesive layer a/heat-generating element b/melt-softening layer c/functional layer/pressure sensitive adhesive layer a
Peeling layer/pressure sensitive adhesive layer a/functional layer/heat-generating element b/melt-softening layer c/pressure sensitive adhesive layer a/peeling layer
Peeling layer/pressure sensitive adhesive layer a/functional layer/heat-generating element b/melt-softening layer c/functional layer/pressure sensitive adhesive layer a/peeling layer
Peeling layer/pressure sensitive adhesive layer a/melt-softening layer c/heat-generating element b/melt-softening layer c/peeling layer

The thickness of the entire pressure sensitive adhesive tape according to the present invention is preferably in a range of 50 μm to 2,000 μm, more preferably in a range of 50 μm to 1,000 μm, and still more preferably in a range of 50 μm to 800 μm. In this case, functions such as cushioning properties (flexibility) can also be imparted to the pressure sensitive adhesive tape in a case of bonding adherends, and the handleability of the pressure sensitive adhesive tape, such as mechanical strength or processability, can be further improved.

### [Applications of Pressure Sensitive Adhesive Tape]

The both surfaces of the pressure sensitive adhesive tape of the present invention, excluding the peeling layer, function as a surface (adhesive surface) having adhesiveness, adherends can be respectively bonded to the both surfaces of the pressure sensitive adhesive tape, and thus the pressure sensitive adhesive tape can be suitably used for bonding the adherends to each other. The pressure sensitive adhesive tape of the present invention can be peeled off when heated, suitably resistance-heated, and thus can be suitably used particularly as resistance heating (electrical conduction heating) peeling tape.

The pressure sensitive adhesive tape of the present invention can be suitably used for bonding adherends, which are rigid objects, to each other and separating the adherends from each other. The pressure sensitive adhesive tape of the present invention can be easily peeled off when heated, and thus can be used for applications where peeling of the pressure sensitive adhesive tape is required in a case of separating components from each other for the purpose of reuse or recycling. For example, the pressure sensitive adhesive tape of the present invention can be suitably used as a pressure sensitive adhesive tape that fixes components of various products to each other in the industrial applications such as electronic devices, automobiles, building materials, office automation, and household electric appliances, and work efficiency in a case of separating components from each other or peeling off labels is improved.

### [Method of Producing Pressure Sensitive Adhesive Tape]

A method of producing the pressure sensitive adhesive tape according to the present invention is not particularly limited. For example, the pressure sensitive adhesive tape according to the first aspect of the present invention described above can be produced by performing a method of coating a peeling sheet with a composition containing components and solvents constituting the pressure sensitive adhesive layer, drying the peeling sheet to form a pressure sensitive adhesive layer, coating another peeling sheet with a composition containing components and solvents constituting the melt-softening layer, drying the peeling sheet to form a melt-softening layer, and sequentially bonding these sheets to each surface of the planar heat-generating element. Here, the pressure sensitive adhesive tape according to the second aspect of the present invention described above can be produced by peeling the peeling sheet on the surface side of the melt-softening layer of the obtained pressure sensitive adhesive tape and further bonding the pressure sensitive adhesive layer formed in a shape of a peeling sheet to the exposed surface of the melt-softening layer.

Alternatively, the pressure sensitive adhesive tape according to the first aspect of the present invention described above can be produced by bonding the pressure sensitive adhesive layer formed in a shape of the peeling sheet to one surface of the planar heat-generating element, coating the other surface of the planar heat-generating element with a composition containing components and solvents constituting the melt-softening layer, and drying the resulting layer to form a melt-softening layer. Further, the pressure sensitive adhesive tape according to the second aspect of the present invention described above can be produced by further bonding the pressure sensitive adhesive layer formed in a shape of the peeling sheet to the surface of the melt-softening layer of the obtained pressure sensitive adhesive tape.

Further, the composition containing components constituting the pressure sensitive adhesive layer and the composition containing components constituting the melt-softening layer may be molded by extrusion molding, press molding, injection molding, or the like.

The solvent is not particularly limited, and examples thereof include an organic solvent such as toluene, xylene, ethyl acetate, butyl acetate, acetone, methyl ethyl ketone, or hexane, water, and an aqueous solvent having water as a main component. Further, the solvent may remain in the pressure sensitive adhesive layer and the melt-softening layer of the pressure sensitive adhesive tape to be obtained, but it is preferable that the pressure sensitive adhesive tape and the melt-softening layer typically do not contain a solvent.

### 2. Article

The present invention also relates to an article including at least two adherends and the pressure sensitive adhesive tape of the present invention between the two adherends, in which the two adherends are bonded to each other through the pressure sensitive adhesive tape.

The adherend may have rigidity, and flexibility such as a film. The material and the shape of the adherend are not particularly limited, and examples of the adherend include a plate-like adherend formed of a resin, glass, or a metal, a housing, a cover, and a component having any of these on the adhesive surface.

Two adherends bonded to each other through the pressure sensitive adhesive tape may be the same as or different from each other. Examples of a method of bonding adherends include a method of attaching the adherends to each adhesive surface of the pressure sensitive adhesive tape according to the present invention and bonding the two adherends to each other.

The article is not particularly limited, but an electronic device, a component built in an electronic device, or the like is preferable from the viewpoint of effectively using the effects exhibited by the pressure sensitive adhesive tape according to the present invention.

It is preferable that the article of the present invention be formed such that the heat-generating element constituting the pressure sensitive adhesive tape has a pair of extending portion extending from the outer peripheries of the adherends in plan view.

An article 100 of the present invention is, for example, an article including two adherends 50 and the pressure sensitive adhesive tape 10 that includes a laminate in which the pressure sensitive adhesive layer a, the planar heat-generating element b, and the melt-softening layer c are laminated in this order between the two adherends 50, in which the two adherends 50 are bonded to each other through the pressure sensitive adhesive tape 10 as shown in FIG. 6 which is a schematic plan view and FIG. 7 which is a schematic cross-sectional view. In plan view (FIG. 6), both ends of the planar heat-generating element b in the major axis direction extend from the outer peripheries of the pressure sensitive adhesive layer a and the melt-softening layer c.

The extending both ends of the pressure sensitive adhesive tape 10 can be used as a pair of terminals for being electrically connected to a power source or end portions coming into contact with a heat-generating source in a case where the heating means is any of resistance heating or thermal conduction in a method of dismantling the article described below, and can easily heat the heat-generating element b of the pressure sensitive adhesive tape 10. Further, as shown in FIG. 6, it is advantageous that the contact area between the adherend and the pressure sensitive adhesive tape decreases in plan view in terms that the heat-generating element has high heat generation efficiency and heating of the pressure sensitive adhesive tape can easily cause dismantling of the article so that the article is easily dismantled.

Although not shown, the article of the present invention may be an article including two adherends and the pressure sensitive adhesive tape shown in FIG. 5 provided between the two adherends, in which the two adherends are bonded to each other through the pressure sensitive adhesive tape.

In plan view of the article, the pressure sensitive adhesive tape may be bonded to the entire adherend surface of the adherend, which is the surface on the pressure sensitive adhesive tape side, or the pressure sensitive adhesive tape may be bonded to a part of the adherend surface of the adherend. Among these, as shown in FIG. 6, it is preferable that the pressure sensitive adhesive tape 10 be bonded to a part of the adherend surface of the adherend 50. In this case, the shape of the pressure sensitive adhesive tape 10 in the article in plan view may be band-like, linear, or pattern-like. It is advantageous that the contact area between the adherend and the pressure sensitive adhesive tape decreases in terms that a starting point of peeling between the adherend and the pressure sensitive adhesive tape is easily generated in a case of peeling off the pressure sensitive adhesive tape from the adherend by resistance heating, and thus the pressure sensitive adhesive tape is easily peeled off.

Further, in a case where the pressure sensitive adhesive tape is bonded to the entire adherend surface of the adherend, which is the surface on the pressure sensitive adhesive tape side, in plan view of the article according to the present invention, the shape of the planar heat-generating element in the pressure sensitive adhesive tape in plan view may be the same shape as the shape of the pressure sensitive adhesive tape in plan view, or may be band-like, linear, or pattern-like.

### 3. Method of Dismantling Article

The present invention relates to a method of dismantling the article according to the present invention described above, which is a method of dismantling the article, including melting or softening the melt-softening layer by heating the heat-generating element to separate the two adherends from each other.

The dismantling method of the present invention suitably includes a step (separation step) of melting or softening the melt-softening layer by heating the heat-generating element to separate at least two adherends from each other and may further include other steps as necessary.

The means and the method of heating the heat-generating element are not particularly limited, and examples thereof include resistance heating, electromagnetic induction heating, infrared heating, microwave heating, and thermal conduction. Among these, resistance heating is preferable.

In a case where the heating of the heat-generating element is resistance heating, it is preferable that the separation step be a step of in which the heat-generating element and the power source are electrically connected to each other, the heat-generating element is electrically conducted from the power source, and the melt-softening layer adjacent to the heat-generating element is melted or softened by resistance heating to separate two adherends from each other.

The power source may be an external power source or a driving power source of an article that is an electronic device or a component built in an electronic device. Further, in a case where the article is an electronic device or a component built in an electronic device, and the power source is a driving power source of an electronic device, it is preferable that the separation step be a step in which the heat-generating element, the driving power source of the electronic device, and an electric circuit are electrically connected to each other, the heat-generating element is electrically conducted from the driving power source, and the melt-softening layer is melted or softened by resistance heating to separate two adherends from each other.

The electrical connection may be performed by a method of electrically connecting the heat-generating element or a pair of extending portions of the heat-generating element extending from the outer peripheries of the pressure sensitive adhesive layer and the melt-softening layer, and the power source to each other using, for example, known means such as alligator clips. The electric circuit and the electrical connection means are formed preferably by an electrically conducting material exhibiting a volume resistivity different from that of the material of the heat-generating element in the pressure sensitive adhesive tape and more preferably by an electrically conducting material with a volume resistivity less than that of the heat-generating element. In this case, the above-described method is advantageous in terms that a voltage is efficiently applied to the heat-generating element and the pressure sensitive adhesive tape can be peeled off in a short time while the electric circuit and the electrical connection means are prevented from being excessively heated when the heat-generating element and the electric circuit are electrically connected to each other and the heat-generating element is electrically conducted from the driving power source.

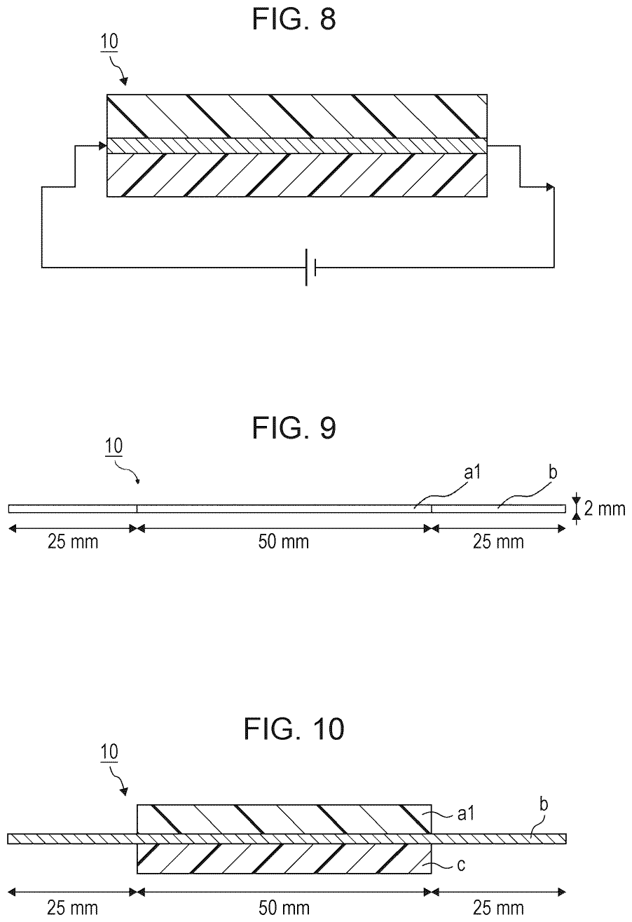

A method of performing electrical conduction can be appropriately selected according to the size of the pressure sensitive adhesive tape according to the present invention and the kind or the like of the heat-generating element, and examples of the method include a method of applying a voltage of 0.1 to 200 V until the melt-softening layer is melted or softened (for example, in a range of 0.5 seconds to 30 minutes). As schematically shown in FIG. 8, a simple power source can be used. In a case where the heat-generating element of the pressure sensitive adhesive tape according to the present invention and the power source are electrically connected and the voltage is applied to the heat-generating element for electrical conduction, the heat-generating element and the periphery thereof can be heated by resistance heating. The melt-softening layer is melted or softened by such heating so that the bonded state is released, and the adherends bonded to each other can be dismantled.

The voltage to be applied to the heat-generating element through electrical conduction is typically preferably in a range of 0.1 to 200 V, more preferably in a range of 0.5 to 150 V, and still more preferably in a range of 1.0 to 100 V. In the pressure sensitive adhesive tape of the present invention, the melt-softening layer is melted and softened in a short time even when the voltage applied to the heat-generating element is small, the article can be dismantled in a short time without applying an excessive voltage so that damage to the article due to heat can be prevented by setting the voltage to be applied in the separation step to be in the above-described ranges. Particularly, when the voltage that can be handled by articles such as small-sized electronic devices or household electric appliances is applied, these articles can be easily dismantled.

The current to be applied to the heat-generating element is not particularly limited, but is typically preferably in a range of 0.01 to 20 A, more preferably in a range of 0.03 to 15 A, still more preferably in a range of 0.05 to 10 A, and particularly preferably in a range of 0.1 to 5 A. In the pressure sensitive adhesive tape of the present invention, since the melt-softening layer is melted and softened in a short time, the article can be dismantled in a short time by allowing the current flowing in general-purpose electronic devices or household electric appliances to flow in the heat-generating element so that damage to the article due to heat can be prevented by setting the current to be applied in the separation step to be in the above-described ranges. Particularly, when the current that can be handled by small-sized electronic devices or household electric appliances is applied, these articles can be easily dismantled.

The application time is not particularly limited, but is typically preferably in a range of 0.5 seconds to 30 minutes, more preferably in a range of 0.5 seconds to 120 seconds, and still more preferably in a range of 0.5 seconds to 30 seconds. When the application time is set to be in the above-described ranges, the article can be easily dismantled in a short time without damaging the article due to heat.

When the heating of the heat-generating element is electromagnetic induction heating, it is preferable that the separation step be a step of melting or softening the melt-softening layer by electromagnetic induction heating using electromagnetic induction heating means to separate the two adherends from each other. The electromagnetic induction heating means is not particularly limited, and a known electromagnetic induction heating device can be appropriately used.

In a case where the heating of the heat-generating element is any of infrared heating or microwave heating, it is preferable that the separation step be a step of melting or softening the melt-softening layer by any of infrared heating using infrared heating means or microwave heating using microwave heating means to separate the two adherends from each other. The infrared heating means and the microwave heating means are not particularly limited, and a known infrared heating device and a known microwave heating device can be appropriately selected.

In a case where the heating of the heat-generating element is thermal conduction, it is preferable that the separation step be a step of bringing the heat-generating element and the heat-generating source into contact with each other and melting or softening the melt-softening layer by thermal conduction to separate the two adherends from each other. The heat-generating source is not particularly limited, and a known heater can be appropriately selected. A method of the thermal conduction using a heat-generating element can be appropriately selected according to the size of the pressure sensitive adhesive tape and the kind or the like of the heat-generating element, and examples of the method include a method of bringing the heat-generating element and the heat-generating source into contact with each other until the melt-softening layer is melted or softened at a desired temperature.

The dismantling temperature of the article is preferably in a range of 80° C. to 160° C., more preferably in a range of 90° C. to 150° C., and still more preferably in a range of 100° C. to 130° C. When the dismantling temperature thereof is set to be in the above-described ranges, the thermal damage to the article and the adherends can be suppressed, and the article can be easily dismantled. Particularly in a case where the heating of the pressure sensitive adhesive tape is resistance heating (electrical conduction heating), heat is directly generated inside the tape, and thus the article can be dismantled before the heat is transferred to the article and the adherends.

The dismantling temperature of the article can be measured as the temperature (reaching temperature of the heat-generating element during dismantling) of the heat-generating element of the pressure sensitive adhesive tape according to the present invention using a temperature sensor formed of a thermocouple.

Hereinbefore, the embodiments of the pressure sensitive adhesive tape, the article, and the method of dismantling the article according to the present invention have been described, but the present invention is not limited to the configurations of the embodiments described above. For example, in the configurations of the pressure sensitive adhesive tape according to the above-described embodiment of the present invention, other optional configurations may be added thereto, or the configurations of the embodiment may be replaced with optional configurations producing the same effects as described above.

### EXAMPLES

Hereinafter, the present invention will be described in detail with reference to examples. Here, the present invention is not limited to the examples described below. Materials used in the present examples and the like are described below.

### <Inorganic Hollow Filler>

Hollow filler 1: “Glass Bubbles S38” (trade name, manufactured by 3M Company, average particle diameter (median diameter) of 40 μm, true density of 0.38 g/cm³)
Hollow filler 2: “Glass Bubbles K15” (trade name, manufactured by 3M Company, average particle diameter of 60 μm, true density of 0.15 g/cm³)

### <Heat-Generating Element>

Nichrome foil: “Nichrome NCH1-H” [trade name, manufactured by TAKEUCHI METAL FOIL & POWDER CO., LTD., thickness of 10 μm, volume resistivity of 108 μΩ·cm (catalog value), 105 μΩ·cm (measured value)

### <Peeling Layer>

Release liner: polyethylene terephthalate film with thickness of 75 μm, having one surface subjected to peeling treatment

### <Constituent Material of Melt-Softening Layer (Melt-Softening Resin Composition) Excluding Inorganic Hollow Filler>

### Example 1

100 parts by mass of a styrene-isoprene block copolymer composition (mixture of styrene-isoprene diblock copolymer and styrene triblock copolymer; 24% by mass of structural unit derived from styrene, proportion of styrene-isoprene diblock copolymer in total amount of composition: 67% by mass), 40 parts by mass of Quintone G115 (manufactured by ZEON CORPORATION, C₅/C₉ petroleum-based resin, softening point of 115° C.), 30 parts by mass of Pensel D-160 (manufactured by ARAKAWA CHEMICAL INDUSTRIES, LTD., polymerized rosin ester resin, softening point of 15° C. to 150° C.), 5 parts by mass of Nisseki Polybutene HV-50 (manufactured by ENEOS Corporation, polybutene, pour point: −12.5° C.), and 1 part by mass of an aging inhibitor (tetrakis [methylene-3-(3′5′-dit-butyl-4-hydroxyphenyl) propionate]methane) were mixed and dissolved in 100 parts by mass of toluene as a solvent, thereby obtaining a resin composition (P-1).

The surface of the release liner subjected to a peeling treatment was coated with the obtained resin composition (P-1) such that the thickness of the composition after drying the composition reached about 2 mm to prepare a layer (P-1), and the storage elastic modulus G′ and the loss elastic modulus (G″) were measured under conditions of a temperature range of −40° C. to 200° C. and a temperature increase rate of 2° C./min at a frequency of 1 Hz using a viscoelasticity tester (ARES-G2, manufactured by TA Instruments Japan Inc.). Further, the tan δ of the above-described resin composition (P-1) at a frequency of 1 Hz was determined according to the calculation formula [tan δ=G″/G′].

The melting point of the resin composition (P-1) was 140° C., the storage elastic modulus G23 at 23° C. was 2.5×10⁵ Pa, the storage elastic modulus G120 at 120° C. was 5.0×10⁴ Pa, and the temperature when the tan δ was 0.8 was 125° C. (temperature at which the tan δ was 0.8 or greater was 125° C. or higher).

### <Constituent Material of Pressure Sensitive Adhesive Layer>

### Preparation Example 2

A reaction container provided with a stirrer, a reflux condenser, a nitrogen introduction pipe, and a thermometer was charged with 79.9 parts by mass of n-butyl acrylate, 6 parts by mass of 2-ethylhexyl acrylate, 10 parts by mass of cyclohexyl acrylate, 4 parts by mass of acrylic acid, 0.1 parts by mass of 4-hydroxybutyl acrylate, and 200 parts by mass of ethyl acetate and subjected to nitrogen bubbling at 23° C. for 1 hour while being stirred, thereby obtaining a mixture. Next, 2 parts by mass (solid content of 1.0% by mass) of a 2,2′-azobis (2-methylbutyronitrile) solution which had been dissolved in ethyl acetate in advance was added to the mixture, and the mixture was stirred at 72° C. for 4 hours and further stirred at 75° C. for 5 hours. Next, the obtained mixture was diluted with ethyl acetate and filtered through a 200-mesh wire, thereby obtaining an acrylic copolymer (A-1) solution (solid content concentration of 26%) in which the weight-average molecular weight was 1,060, 000 and the average number of carbon atoms in a saturated hydrocarbon group of an alkyl acrylate monomer was 4.4. Next, 1.0 parts by mass of an adduct (“BURNOCK D-40”, manufactured by DIC Corporation, isocyanate-based crosslinking agent, solid content of 40%, hereinafter, also referred to as “D-40”) of tolylene diisocyanate and trimethylolpropane was blended, as a crosslinking agent, into 100 parts by mass of the obtained acrylic copolymer (A-1) solution, thereby obtaining a composition (P-2).

The surface of the release liner subjected to a peeling treatment was coated with the obtained composition (P-2) such that the thickness of the composition after drying the composition reached about 2 mm to prepare a layer (P-2), and the storage elastic modulus G′ and the loss elastic modulus (G″) were measured under conditions of a temperature range of −40° C. to 200° C. and a temperature increase rate of 2° C./min at a frequency of 1 Hz using a viscoelasticity tester (ARES-G2, manufactured by TA Instruments Japan Inc.). Further, the tan δ of the above-described composition (P-2) at a frequency of 1 Hz was determined according to the calculation formula [tan δ=G″/G′].

The melting point of the composition (P-2) was 150° C. or higher, the storage elastic modulus G23 at 23° C. was 7.5×10⁴ Pa, the storage elastic modulus G120 at 120° C. was 5.5×10⁴ Pa, and the temperature when the tan δ was 0.8 was higher than 150° C. (temperature at which the tan δ was 0.8 or greater was higher than 150° C.). Further, the maximum value of the tan δ in a temperature range of 100° C. to 150° C. was 0.4.

### 1. Preparation Example of Pressure Sensitive Adhesive Tape and Article

### Example 1

### <Preparation of Pressure Sensitive Adhesive Tape>

30% by volume of the hollow filler 1 was mixed into the resin composition (P-1) to obtain a pressure sensitive adhesive (Y-1). The surface of the release liner subjected to a peeling treatment was coated with the pressure sensitive adhesive (Y-1) such that the thickness of the pressure sensitive adhesive after drying the pressure sensitive adhesive reached 100 μm, and dried at 90° C. for 5 minutes, thereby obtaining a melt-softening layer c1 (thermal conductivity of 0.18 W/m·K).

Further, the surface of another release liner subjected to a peeling treatment was coated with the resin composition (P-2) such that the thickness of the resin composition after drying the resin composition reached 50 μm, and dried at 90° C. for 3 minutes, thereby obtaining a pressure sensitive adhesive layer (thermal conductivity of 0.20 W/m·K).

The melt-softening layer c1 cut to have a length of 50 mm and an optional width and nichrome foil having a length of 100 mm were bonded with a hand roller and positioned such that both ends of the nichrome foil extended in the length direction by 25 mm. Similarly, the pressure sensitive adhesive layer cut to have a length of 50 mm and an optional width was bonded to the surface of the nichrome foil opposite to the surface to which the melt-softening layer c1 had been bonded, and laminated from the upper surface of the release liner using a roll with a linear load of 5 kg/cm, and the laminate was aged in an environment of 40° C. for 48 hours. In this manner, the total thickness of the shape, excluding the release liner, in which both ends of the nichrome foil extended by 25 mm in the length direction from the outer peripheries of the melt-softening layer c1 and the pressure sensitive adhesive layer was 160 μm, and a laminate having a layer configuration excluding the release liner, obtained by laminating the pressure sensitive adhesive layer a1, the nichrome foil b, and the melt-softening layer c1 in this order was prepared.

The obtained laminate was cut into a width of 2 mm, thereby obtaining a pressure sensitive adhesive tape (T-1) in which the melt-softening layer c1 and the pressure sensitive adhesive layer a1 had a width of 2 mm and a length of 50 mm, the nichrome foil b had a size of a width of 2 mm and a length of 100 mm, and the nichrome foil b had a pair of extending portions extending from the outer peripheries of the melt-softening layer c1 and the pressure sensitive adhesive a1. FIG. 9 is a schematic plan view showing the pressure sensitive adhesive tape (T-1), and FIG. 10 is a schematic cross-sectional view showing the pressure sensitive adhesive tape (T-1).

### <Preparation of Article>

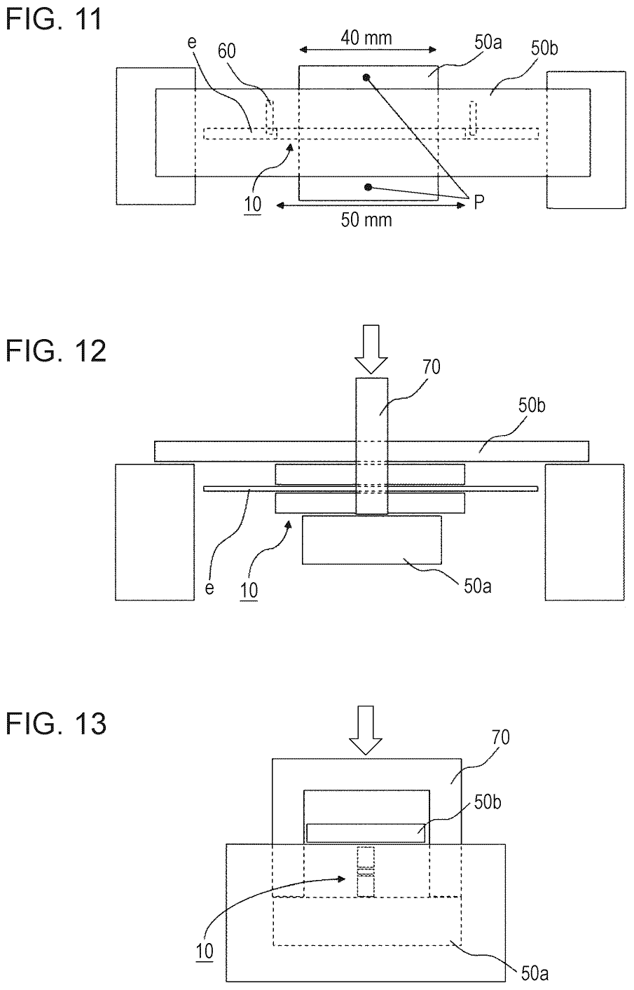

The release liner of the pressure sensitive adhesive tape (FIGS. 11 to 13, denoted by the reference numeral 10) of Example 1 on the side of the melt-softening layer c1 was peeled off, the tape adhesive surface (active portion) with a length of 50 mm was bonded to an adherend 50a (glass with a width of 40 mm, a length of 50 mm, and a thickness of 10 mm) to cross the center of the adherend 50a in the width direction of the adherend 50a (see FIGS. 11 to 13). Next, the release liner on the side of the pressure sensitive adhesive layer a1 was peeled off, the adherend 50b (glass with a width of 30 mm, a length of 100 mm, and a thickness of 2.8 mm) was attached thereto to sandwich the pressure sensitive adhesive tape 10 (see FIGS. 11 to 13) and pressure-bonded at 20 N/cm² for 10 seconds, the obtained attached material was allowed to stand in an atmosphere of 23° C. and 50% RH for 24 hours or longer, thereby obtaining an article of Example 1.

### Example 2

60% by volume of the hollow filler 1 was mixed into the resin composition (P-1) to obtain a pressure sensitive adhesive (Y-2). The surface of the release liner subjected to a peeling treatment was coated with the pressure sensitive adhesive (Y-2) such that the thickness of the pressure sensitive adhesive after drying the pressure sensitive adhesive reached 100 μm, and dried at 90° C. for 5 minutes, thereby obtaining a melt-softening layer c2 (thermal conductivity of 0.16 W/m·K).

Thereafter, a pressure sensitive adhesive tape (T-2) and an article of Example 2 were prepared by the same procedures as in Example 1.

### Example 3

60% by volume of the hollow filler 1 was mixed into the resin composition (P-1) to obtain a pressure sensitive adhesive (Y-2). The surface of the release liner subjected to a peeling treatment was coated with the pressure sensitive adhesive (Y-2) such that the thickness of the pressure sensitive adhesive after drying the pressure sensitive adhesive reached 100 μm, and dried at 90° C. for 5 minutes, thereby obtaining a melt-softening layer c3 (thermal conductivity of 0.16 W/m·K).

Thereafter, a pressure sensitive adhesive tape (T-3) and an article of Example 3 were prepared by the same procedures as in Example 1.

### Example 4

60% by volume of the hollow filler 2 was mixed into the resin composition (P-1) to obtain a pressure sensitive adhesive (Y-4). The surface of the release liner subjected to a peeling treatment was coated with the pressure sensitive adhesive agent (Y-4) such that the thickness of the pressure sensitive adhesive after drying the pressure sensitive adhesive reached 100 μm, and dried at 90° C. for 5 minutes, thereby obtaining a melt-softening layer c4 (thermal conductivity of 0.13 W/m·K).

Thereafter, a pressure sensitive adhesive tape (T-4) and an article of Example 4 were prepared by the same procedures as in Example 1.

### Comparative Example 1

The surface of the release liner subjected to a peeling treatment was coated with the resin composition (P-1) such that the thickness of the resin composition after drying the resin composition reached 100 μm, and dried at 90° C. for 5 minutes, thereby obtaining a melt-softening layer c0 (thermal conductivity of 0.20 W/m·K).

Thereafter, a pressure sensitive adhesive tape (CT-1) and an article of Comparative Example 1 were prepared by the same procedures as in Example 1.

### Example 5

### <Preparation of Pressure Sensitive Adhesive Tape>

The melt-softening layer c1 and the pressure sensitive adhesive layer were prepared in the same manner as in Example 1.

The melt-softening layer c1 cut to have a length of 50 mm and an optional width and nichrome foil having a length of 100 mm were bonded with a hand roller and positioned such that both ends of the nichrome foil extended in the length direction by 25 mm. Similarly, the pressure sensitive adhesive layer cut to have a length of 50 mm and an optional width was bonded to the surface of the nichrome foil opposite to the surface to which the melt-softening layer c1 had been bonded, and laminated from the upper surface of the release liner using a roll with a linear load of 5 kg/cm.

Next, the pressure sensitive adhesive layer cut to have a length of 50 mm and an optional width was bonded to the surface of the melt-softening layer c1 from which the release liner had been peeled off, and laminated from the upper surface of the release liner using a roll with a linear load of 5 kg/cm, and the laminate was aged in an environment of 40° C. for 48 hours. In this manner, the total thickness of the shape, excluding the release liner, in which both ends of the nichrome foil extended by 25 mm in the length direction from the outer peripheries of the melt-softening layer and the pressure sensitive adhesive layer was 210 μm, and a laminate having a layer configuration excluding the release liner, obtained by laminating the pressure sensitive adhesive layer a1, the nichrome foil b, the melt-softening layer c1, and the pressure sensitive adhesive layer a2 in this order was prepared.

The obtained laminate was cut into a width of 2 mm, thereby obtaining a pressure sensitive adhesive tape (T-5) in which the melt-softening layer and the pressure sensitive adhesive layer had a width of 2 mm and a length of 50 mm, the nichrome foil had a size of a width of 2 mm and a length of 100 mm, and the nichrome foil had a pair of extending portions extending from the outer peripheries of the melt-softening layer and the pressure sensitive adhesive layer.

### <Preparation of Article>

The release liner of the pressure sensitive adhesive tape (FIGS. 11 to 13, denoted by the reference numeral 10) of Example 5 on the side of one pressure sensitive adhesive layer a1 was peeled off, the tape adhesive surface (active portion) with a length of 50 mm was bonded to an adherend 50a (glass with a width of 40 mm, a length of 50 mm, and a thickness of 10 mm) to cross the center of the adherend 50a in the width direction of the adherend 50a (see FIGS. 11 to 13). Next, the release liner on the side of the other pressure sensitive adhesive layer a2 was peeled off, the adherend 50b (glass with a width of 30 mm, a length of 100 mm, and a thickness of 2.8 mm) was attached thereto to sandwich the pressure sensitive adhesive tape 10 (see FIGS. 11 to 13) and pressure-bonded at 20 N/cm² for 10 seconds, the obtained attached material was allowed to stand in an atmosphere of 23° C. and 50% RH for 24 hours or longer, thereby obtaining an article of Example 5.

### Example 6

30% by volume of the hollow filler 2 was mixed into the resin composition (P-1) to obtain a pressure sensitive adhesive (Y-3). The surface of the release liner subjected to a peeling treatment was coated with the pressure sensitive adhesive (Y-3) such that the thickness of the pressure sensitive adhesive after drying the pressure sensitive adhesive reached 100 μm, and dried at 90° C. for 5 minutes, thereby obtaining a melt-softening layer c3 (thermal conductivity of 0.18 W/m·K).

A pressure sensitive adhesive tape (T-6) and an article of Example 6 were prepared by the same procedures as in Example 5 except that the melt-softening layer c2 was used in place of the melt-softening layer c1 in Example 5.

### Example 7

30% by volume of the hollow filler 2 was mixed into the resin composition (P-1) to obtain a pressure sensitive adhesive (Y-3). The surface of the release liner subjected to a peeling treatment was coated with the pressure sensitive adhesive (Y-3) such that the thickness of the pressure sensitive adhesive after drying the pressure sensitive adhesive reached 100 μm, and dried at 90° C. for 5 minutes, thereby obtaining a melt-softening layer c3 (thermal conductivity of 0.16 W/m·K).

A pressure sensitive adhesive tape (T-7) and an article of Example 7 were prepared by the same procedures as in Example 5 except that the melt-softening layer c4 was used in place of the melt-softening layer c1 in Example 5.

Further, the thermal conductivities of the melt-softening layer and the pressure sensitive adhesive layer in each example and the comparative example are values measured by a rapid thermal conductivity meter (“QTM-710”, manufactured by Kyoto Electronics Manufacturing Co., Ltd.).

### 2. Evaluation

The push strength of the article obtained in each example and the comparative example was measured in the following manner using a device shown in FIGS. 11 to 13.

### (1) Push Strength Before Heating

A glass plate was pushed by a probe 70 shown in FIGS. 12 and 13 at a pressing position shown in FIG. 11 at a rate of 10 mm/min in an environment of 23° C. in a direction indicated by the arrow using the article obtained in each example and the comparative example as the test piece, and the strength [push strength (G1)] at which the pressure sensitive adhesive tape was peeled off was measured.

(2) Push Strength 10 Seconds after Heating

The extending portion e of the nichrome foil (heat-generating element) in the pressure sensitive adhesive tape 10 of each test piece was clamped with an alligator clip 60 using the article obtained in each example and the comparative example as the test piece, and a current of 0.5 A or 1.0 A was allowed to flow using a DC stabilized power source (trade name “PAS160-1”, manufactured by KIKUSUI ELECTRONICS CORP.). The glass plate was pushed by the probe 70 shown in FIGS. 12 and 13 at a rate of 10 mm/min in the direction indicated by the arrow while electrical conduction was maintained 10 seconds after the start of the electrical conduction, and the strength [push strength (G2)] at which the pressure sensitive adhesive tape was peeled off was measured.

Further, the reaching temperature of the heat-generating element (dismantling temperature of the article) in a case of dismantling the article by electrical conduction heating at 0.5 A was about 100° C., and the reaching temperature of the heat-generating element (dismantling temperature of the article) in a case of dismantling the article by electrical conduction heating at 1.0 A was about 160° C.

The temperature of the heat-generating element after the electrical conduction was measured by a temperature sensor formed of a thermocouple.

### (3) Residual Adhesive Strength and Rate of Decrease in Push Strength

The residual adhesive strength and the rate of decrease in push strength were calculated by the following equations using the push strength (G1) and the push strength (G2), and the dismantling properties were evaluated according to the following criteria.

Residual adhesive strength (%)=100×G2/G1

Rate of decrease in push strength (%)=100×[1−(G2/G1)]

### [Evaluation Criteria for Dismantling Properties]

⊚: The residual adhesive strength was less than 50%.
o: The residual adhesive strength was 50% or greater and less than 65%.
Δ: The residual adhesive strength was 65% or greater.

The results described above are collectively listed in Table 1.

TABLE 1

| | Comparative | | | | | | | |
|---|---|---|---|---|---|---|---|---|
| | Example 1 | Example 1 | Example 2 | Example 3 | Example 4 | Example 5 | Example 6 | Example 7 |
| Initial (before | | | | | | | | |
| electrical | | | | | | | | |
| conduction heating) | | | | | | | | |
| Push strength | 53.5 | 58.3 | 40.4 | 38.4 | 35.3 | 66.6 | 66.9 | 57.0 |
| (N/0.8 cm²) | | | | | | | | |
| Electrical | | | | | | | | |
| conduction heating | | | | | | | | |
| at 0.5 A | | | | | | | | |
| Push strength | 52.5 | 51.1 | 39.8 | 32.9 | 29.8 | 54.3 | 50.0 | 43.4 |
| (N/0.8 cm²) | | | | | | | | |
| Residual | 98.2 | 87.6 | 98.5 | 85.7 | 84.5 | 81.6 | 74.7 | 76.1 |
| adhesive strength | | | | | | | | |
| [%] | | | | | | | | |
| Electrical | | | | | | | | |
| conduction heating | | | | | | | | |
| at 1 A | | | | | | | | |
| Push strength | 39.3 | 33.4 | 23.9 | 23.9 | 19.3 | 43.2 | 32.6 | 24.0 |
| (N/0.8 cm²) | | | | | | | | |
| Residual | 73.6 | 57.3 | 59.2 | 62.4 | 54.6 | 64.9 | 48.7 | 42.2 |
| adhesive strength | | | | | | | | |
| [%] | | | | | | | | |
| Rate of decrease | 26.4 | 42.7 | 40.8 | 37.6 | 45.4 | 35.1 | 51.3 | 57.8 |
| in push strength | | | | | | | | |
| [%] | | | | | | | | |
| Dismantling | Δ | ◯ | ◯ | ◯ | ◯ | ◯ | ⊚ | ⊚ |
| properties | | | | | | | | |

The pressure sensitive adhesive tape of each example had push strength lower than that of the comparative example after electrical conduction heating. The residual adhesive strength after electrical conduction heating with respect to the initial adhesive strength was small, and the rate of decrease in adhesive strength (rate of decrease in push strength) due to electrical conduction was greater than that of the comparative example particularly when the current for electrical conduction was set to 1 A.

Further, the pressure sensitive adhesive tapes of Examples 5 to 7 in which the pressure sensitive adhesive layer was further provided on a surface of the melt-softening layer opposite to the surface adjacent to the heat-generating element had initial push strength greater than that of the pressure sensitive adhesive tape of the comparative example. Further, the rate of decrease in adhesive strength due to electrical conduction in each of the pressure sensitive adhesive tapes of Examples 5 to 7 was greater than that of the pressure sensitive adhesive tape of the comparative example. That is, the adhesive strength was weakened by the heat from the heat-generating element due to the heat storage effect of the melt-softening layer, and the article prepared by using the pressure sensitive adhesive tape of each example had excellent dismantling properties.

The pressure sensitive adhesive tape of the present invention can be easily peeled off in a short time when heated, thermal damage to adherends can be prevented, and the operation of heating and peeling off the pressure sensitive adhesive tape is easily performed. Therefore, the pressure sensitive adhesive tape of the present invention can be used for applications where peeling of the pressure sensitive adhesive tape is required in a case of separating components from each other for the purpose of reuse or recycling. For example, the pressure sensitive adhesive tape of the present invention can be suitably used as a pressure sensitive adhesive tape that fixes components of various products to each other in the industrial applications such as electronic devices, automobiles, building materials, office automation, and household electric appliances, and work efficiency in a case of separating components from each other or peeling off labels is improved.

Although the disclosure has been described with respect to only a limited number of embodiments, those skilled in the art, having benefit of this disclosure, will appreciate that various other embodiments may be devised without departing from the scope of the present disclosure. Accordingly, the scope of the invention should be limited only by the attached claims.

What is claimed is:

1. A pressure sensitive adhesive tape comprising at least in the following order:
a pressure sensitive adhesive layer;
a heat-generating element; and
a melt-softening layer adjacent to the heat-generating element,
wherein the melt-softening layer contains a thermoplastic resin and an inorganic hollow filler.

2. The pressure sensitive adhesive tape according to claim 1,
wherein the thermoplastic resin constituting the melt-softening layer contains a block copolymer formed of a polymer block having a structural unit derived from an aromatic vinyl compound, and a polymer block having a structural unit derived from a conjugated diene compound or a hydrogenated product thereof.

3. The pressure sensitive adhesive tape according to claim 1,
wherein an amount of the inorganic hollow filler to be blended into the melt-softening layer is in a range of 5% to 80% by volume.

4. The pressure sensitive adhesive tape according to claim 1,
wherein the inorganic hollow filler has an average particle diameter of 1 to 200 μm.

5. The pressure sensitive adhesive tape according to claim 1,
wherein the inorganic hollow filler is at least one or more selected from the group consisting of a glass hollow filler and a silica hollow filler.

6. The pressure sensitive adhesive tape according to claim 1,
wherein the melt-softening layer has a thickness of 10 to 200 μm.

7. The pressure sensitive adhesive tape according to claim 1,
wherein the melt-softening layer has a thermal conductivity of 0.03 to 0.20 W/m·K.

8. The pressure sensitive adhesive tape according to claim 1,
wherein a temperature at which a loss tangent (tan δ) of a component containing the thermoplastic resin, other than the inorganic hollow filler, constituting the melt-softening layer is 0.8 or greater is 80° C. or higher.

9. The pressure sensitive adhesive tape according to claim 1,
wherein a temperature at which a loss tangent (tan δ) of the pressure sensitive adhesive layer is 0.8 or greater is higher than a temperature at which a loss tangent (tan δ) of a component containing the thermoplastic resin, other than the inorganic hollow filler, constituting the melt-softening layer is 0.8 or greater.

10. The pressure sensitive adhesive tape according to claim 1,
wherein a volume resistivity of the heat-generating element at 20° C. is 30 μΩ·cm or greater.

11. The pressure sensitive adhesive tape according to claim 1,
wherein the heat-generating element has a pair of extending portions extending from outer peripheries of the pressure sensitive adhesive layer and the melt-softening layer in plan view.

12. The pressure sensitive adhesive tape according to claim 1, further comprising:
a pressure sensitive adhesive layer on a surface side of the melt-softening layer opposite to a surface adjacent to the heat-generating element.

13. The pressure sensitive adhesive tape according to claim 1,
wherein the melt-softening layer is peelable when heated.

14. The pressure sensitive adhesive tape according to claim 1,
wherein the heat-generating element is an electrically conducting element that generates heat through electrical conduction and is peeled off when the conducting element generates heat.

15. An article comprising:
at least two adherends; and
the pressure sensitive adhesive tape according to claim 1 between the two adherends,
wherein the two adherends are bonded to each other through the pressure sensitive adhesive tape.

16. The article according to claim 15,
wherein the heat-generating element constituting the pressure sensitive adhesive tape has a pair of extending portions extending from outer peripheries of the adherends in plan view.

17. A method of dismantling the article according to claim 15, comprising:
separating the two adherends from each other by heating the heat-generating element to melt and/or soften the melt-softening layer.

18. The method of dismantling an article according to claim 17,
wherein the heating of the heat-generating element is resistance heating, the heat-generating element and a power source are electrically connected to each other, the heat-generating element is electrically conducted from the power source, and the melt-softening layer is melted and/or softened by the resistance heating to separate the two adherends from each other.
